(19) United States
(12) Patent Application Publication
(10) Pub. No.: US 2026/0304111 A1
(43) Pub. Date: Oct. 1, 2026

(54) SYSTEMS AND METHODS FOR WTRU-UPF SECURE COMMUNICATIONS

(71) Applicant: InterDigital Patent Holdings, Inc., Wilmington, DE (US)

(72) Inventors: Yi Zhang, San Jose, CA (US); Samir Ferdi, Kirkland (CA); Alec Brusilovsky, Downingtown, PA (US); Chonggang Wang, Princeton, NJ (US); Robert Gazda, Spring City, PA (US); Zhibi Wang, Woodridge, IL (US)

(73) Assignee: InterDigital Patent Holdings, Inc., Wilmington, DE (US)

(21) Appl. No.: 19/092,369

(22) Filed: Mar. 27, 2025

(51) Int. Cl. H04W 12/0431; H04W 8/22; H04W 12/10

(52) U.S. Cl. CPC H04W 12/0431; H04W 8/22; H04W 12/10

(57) ABSTRACT

A network node may receive a message. The message may include PQC key, for example from a second network node. The network node may determine, for example based on the PQC key, a master shared secret key (MSSK), and/or encapsulate the MSSK into a ciphertext. The network node may send the ciphertext comprising the MSSK, for example to the second network node. The network node may determine, for example based on the MSSK, a second key. The network node may establish and/or modify, for example based on the second key, a secure E2E connection with the second network node for communications. The network node may determine to use the MSSK as a pre-shared key (PSK). The network node may establish and/or modify a communication protocol with the second network node, for example using the PSK.

### BACKGROUND

Quantum computing may change dynamics of computing. A concern of a post-quantum attack may include a perfect forward secrecy attack, that for example may store encrypted data (e.g., now) and later decrypt the data using a quantum computer. This may be referred to as a store-now-decrypt-later and/or harvest-now-decrypt-later attack. Quantum computers may threaten cryptography through powerful algorithms, for example Shor's algorithm and/or Grover's search.

Shor's algorithm may make asymmetric key cryptography (e.g., RSA and/or ECC) vulnerable, for example by using large integer factorization and discrete logarithms. Grover's search algorithm may speed up the search process, which for example may potentially impact symmetric cryptography. Asymmetric key cryptography may be more vulnerable than symmetric key cryptography because quantum computers may be able to break RSA encryption with a 2048-bit key, for example in a short period of time (e.g., in 24 hours).

### SUMMARY

A wireless transmit/receive unit (WTRU) and/or network (e.g., 6GS) may initiate the establishment and/or modification of a secure end to end (E2E) user plane (UP) connection, for example between the WTRU and a user plane function (UPF). Establishment and/or modification of the secure E2E UP connection may utilize a post-quantum cryptography (PQC)-based key exchange. The establishment and/or modification of the secure E2E UP connection may be during protocol data unit (PDU) session establishment and/or PDU session modification.

The WTRU and/or the network (e.g., 6GS) may (e.g., periodically) refresh the PQC-based connection, for example by updating the security keys and/or refresh the connection on an event-driven basis (e.g., a security policy update). The WTRU and/or the network (e.g., the UPF) may generate a master shared key (MSSK), encapsulate the MSSK, add a signature, and/or send the encapsulated MSSK (e.g., to the WTRU and/or the UPF). The WTRU and/or the network may derive a key from the MSSK, for example to obtain a confidentiality/session key (e.g., Ken) for session data encryption/decryption and/or to obtain an integrity key (e.g., Kin) for session data integrity protection. Additionally, or alternatively, the MSSK and/or other key(s) may be used in a secure transport protocol/IP protocol (e.g., TLS, IPSec), for example as a pre-shared key (PSK) for mutual authentication and/or secure connection setup.

The WTRU and the network (e.g., 6GS) may exchange one or more capability of supporting PQC algorithms. The WTRU may detects the network (e.g., 6GS) capability of supporting PQC algorithms, for example through broadcasted SIB and/or via a registration procedure and/or via a PDU session establishment/modification procedure and/or via UE configuration update procedure. The network (e.g., 6GS) may detect the WTRU capability of supporting PQC, for example via registration and/or another procedure (e.g., as herein).

A network node may receive a message. A network node may include a WTRU, RAN node (e.g., gNB), and/or any other (e.g., 6G network function, for example AMF, SMF, UPF, PCF, CA, eAMF, eSMF, eUPF, ePCF, eCA, and/or any other (e.g., 6G) NF. The message may include PQC key, for example from a second network node. The network node may determine, for example based on the PQC key, a master shared secret key (MSSK), and/or encapsulate the MSSK into a ciphertext. The network node may send the ciphertext comprising the MSSK, for example to the second network node. The network node may determine, for example based on the MSSK, a second key. The network node may establish and/or modify, for example based on the second key, a secure E2E connection with the second network node for communications. The network node may determine to use the MSSK as a pre-shared key (PSK). The network node may establish and/or modify a communication protocol with the second network node, for example using the PSK.

The network node may exchange PQC capability information with the second network node. For example, the network node may determine to update a PQC capability associated with the first network node. The network node may send an indication of the PQC capability associated with the first network node to the second network node. The network node may receive a second PQC capability. The second PQC capability may be associated with the second network node. The network node may store the second PQC capability in a memory. The network node may receive, for example from the second network node, an update to a PQC capability associated with the second network node. The network node may send, for example to the second network node, an indication of a PQC capability associated with the first network node.

The second key may include a session key and/or an integrity key. The network node may establish and/or modify the secure E2E connection based on the session key and the integrity key. The message may include an indication to establish and/or modify E2E user plane (UP) security, a PQC certificate associated with the second network node, and/or a protocol data unit (PDU) session identifier (ID) associated with the second network node. The network node may send a disable message to the second network node. The disable message may include an indication to disable the secure connection on the air interface with the second network node. The network node may establish and/or modify a protocol data unit (PDU) connection with the second network node, for example prior to receiving the message including the PQC key. After E2E UP security is established and/or modified between the WTRU and UFP for example, security on the air interface may not be needed. The disable message may be used to disable protection on the air interface, for example confidentiality and/or integrity.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of post-quantum cryptography (PQC)-based key distribution.

FIGS. 3A and 3B is an example of WTRU initiated PQC-based key distribution for end to end (E2E) user plane (UP) security during protocol data unit (PDU) establishment.

FIGS. 4A and 4B are an example of WTRU initiated PQC-based key distribution for E2E user plane security during PDU session modification.

FIGS. 5A, 5B, and 5C are an example of network initiated PQC-based key distribution for E2E user plane security during PDU session modification.

FIGS. 6A, 6B, and 6C are another example of network initiated PQC-based key distribution for E2E user plane security during PDU session modification.

FIG. 7 is an example of a network initiated key distribution procedure during a user configuration update.

FIGS. 8A and 8B are an example of public key infrastructure (PKI)-based key distribution for E2E user plane security.

FIG. 9 is an example of capability information exchange.

FIG. 10 is an example of capability exchange via a WTRU configuration update procedure.

### DETAILED DESCRIPTION

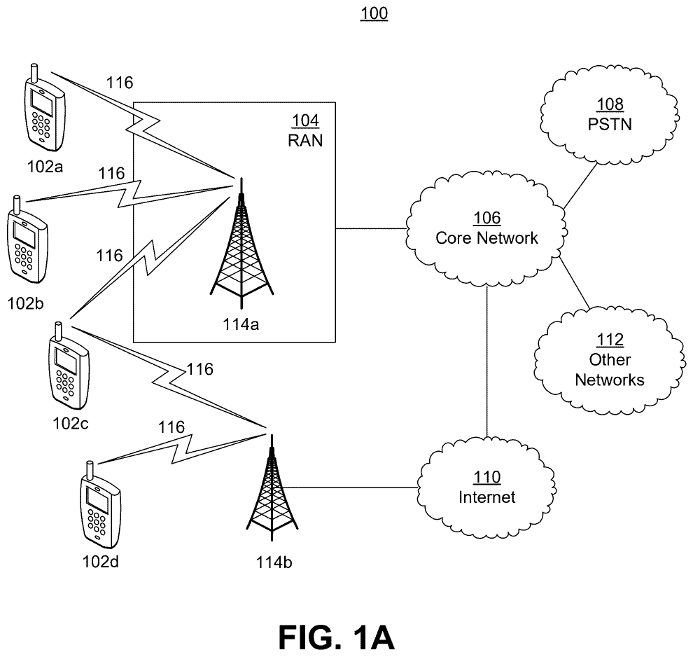

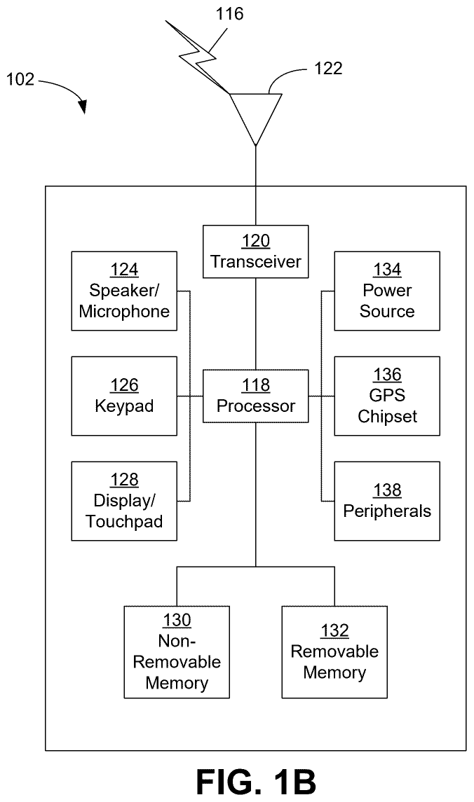

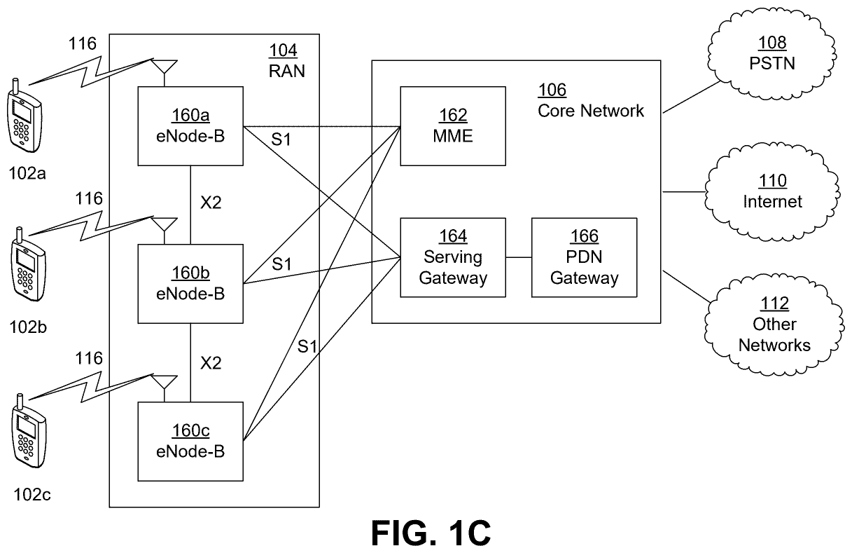

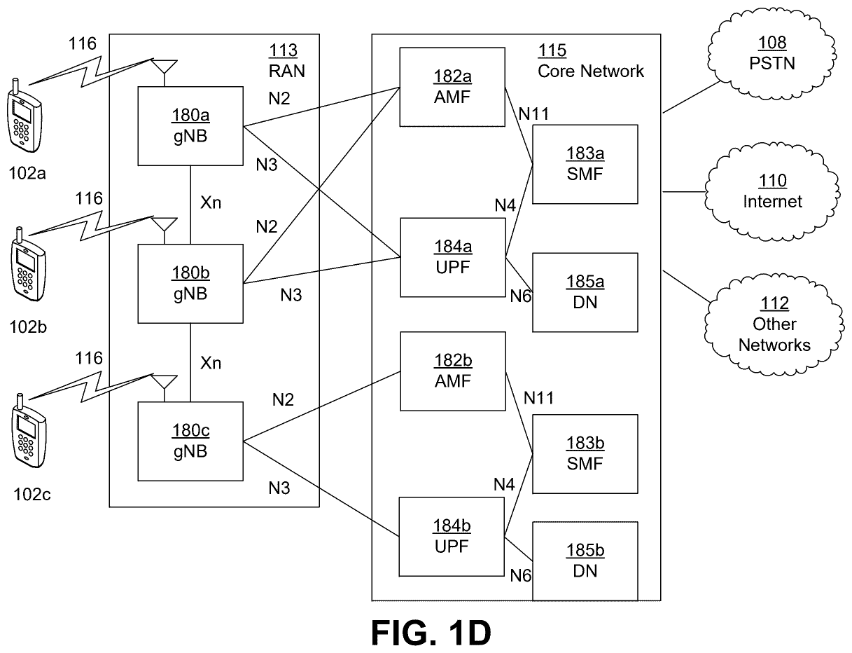

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods may include WTRU initiated PQC-based key distribution for E2E UP security, for example during PDU session establishment and/or modification. Secure E2E UP connection setup and/or modification may use PQC-based key distribution during a PDU Session establishment and/or modification, for example between a WTRU and a network (NW).

A WTRU may send a request, for example to the network. The request may include an indication to setup and/or modify a PDU session, for example with secure end-to-end user plane connection support. The request may include an indication of setup E2E UP security, or an indication of update security key, a selected PQC KEM algorithm, a corresponding security level and/or encapsulation key (PQC.KEM.ek_UE), an indication of whether a PQC-based signature is needed or not, WTRU E2E UP security information, and/or a PDU session ID. The PDU session ID may be a session ID requested by the WTRU for setup and/or modification of the secure E2E user plane connection. WTRU E2E UP security information may include a supported/selected security algorithm(s) for E2E security (e.g., confidentiality and/or integrity) and/or a supported/selected key derivation function(s) to derive the keys for confidentiality and/or integrity protection.

The WTRU may receive a response, for example from the SMF. The response may include ciphertext, an indication of acceptance for secure end-to-end user plane connection establishment and/or modification for the PDU session ID, E2E user plane security information, UPF endpoint identifier information (e.g., IP address and/or FQDN), and/or criteria for PQC-based E2E user plane security update. E2E user plane security information may include a selected security algorithm for E2E security and/or a selected key derivation function by the network.

The WTRU may receive a signature, for example in the response. The WTRU may verify the signature, for example using a network PQC digital signature algorithm (DSA) public key (e.g., if a signature is received). The WTRU may decapsulate the ciphertext, for example using PQC key encapsulation mechanism (KEM) decapsulation key. The WTRU may decapsulate the ciphertext to obtain a master shared secret key (MSSK).

The WTRU may perform a key derivation, for example to obtain a session encryption and/or decryption key, (e.g., Ken) and/or an integrity key (e.g., Kin). Additionally, or alternatively, the WTRU may perform a key derivation to obtain the session encryption and/or decryption key and/or integrity key from the MSSK, for example during a secure connection establishment with a user plane function (UPF) using received UPF endpoint information. The WTRU may disable confidentiality and/or integrity protection on the air interface, for example for (e.g., all) data radio bearers (DRBs) in the PDU session based on a provisioned mobile network operator (MNO) security policy and/or upon receiving the indication (e.g., from RAN and/or SMF).

The network, for example a RAN, may disable the confidentiality and/or integrity protection. The network (e.g., RAN) may disable the confidentiality and/or integrity protection for (e.g., all) DRBs in the PDU session, for example based on the provisioned MNO security policy and/or upon receiving the indication (e.g., from the SMF).

The SMF may send (e.g., forward) the received information (e.g., from the WTRU), for example to a UPF. The SMF may receive a request from the UPF with information to be used for the end-to-end user plane connection termination at the UPF (e.g., ciphertext, signature, and/or PQC DSA sign public key of UPF, (e.g., PQC.DSA.pk_UPF) and/or UPF endpoint identity information (e.g., IP address and/or FQDN). The SMF may send information to be used for the end-to-end user plane connection termination at the UPF (e.g., ciphertext, signature, and/or PQC.DSA.pk_UPF) and/or UPF endpoint identity information (e.g., IP address and/or FQDN) to the WTRU, for example via an AMF/gNB.

The SMF may receive a notification, for example from the UPF, indicating successful WTRU-UPF secure connection establishment and/or modification. The SMF may send an indication, for example to a gNB via AMF. The indication may indicate disabling the confidentiality and/or integrity protection on the air interface, for example after receiving the notification of successful WTRU-UPF secure connection establishment and/or modification.

A UPF may receive a request, for example from a SMF, for an N4 session setup. The request for N4 session setup may include an indication for PQC-based end-to-end user plane connection establishment/modification, WTRU PQC parameter(s), and/or WTRU E2E user plane security information. The UPF may send, for example to the SMF, addressing information to be used for the end-to-end user plane connection termination at the UPF, for example including ciphertext, a signature, and/or PQC.DSA.pk_UPF, UPF end point information. The UPF end point information may include IP address and/or fully qualified domain name (FQDN).

The UPF may receive an indication of success of ciphertext decapsulation, for example from the WTRU. The UPF may establish a secure connection with the WTRU, for example by deriving the confidentiality key for session data encryption and/or decryption, and/or the integrity key for session integrity protection. The UPF may send a notification, for example to the SMF, indicating successful WTRU-UPF secure connection establishment and/or modification.

The network may initiate PQC-based key distribution for E2E UP security, for example during PDU session modification. The network may establish and/or modify a PQC-based secure E2E user plane connection between the WTRU and UPF, for example during a PDU session modification. For example, the PCF, SMF, and/or UPF may initiate the establishment and/or modification of the PQC-based secure E2E user plane connection between the WTRU and UPF. The modification of the PQC-based secure E2E user plane connection between the WTRU and UPF may include security keys update for the user plane. A security keys update may be triggered by a timer expiration, data volume passing a limit, and/or security policy update/change (e.g., protecting the key distribution by the PQC algorithms with the higher security level), for example for secure end-to-end user plane connection modification. Different PQC algorithms with different security levels may be used, for example if there is a security keys update and/or other key management event.

The WTRU may generate a MSSK and/or encapsulate the MSSK into ciphertext, for example for responding to the network. For example, the WTRU may receive a message from the network (e.g., SMF or PCF) via AMF/gNB. The message may be for setup of a secure end-to-end user plane connection and/or an update of an existing secure end-to-end user plane connection. If a UPF PQC key encapsulation mechanism (KEM) encapsulation key is included for example, the WTRU may generate a MSSK and/or encapsulate the MSSK by using the UPF PQC KEM encapsulation key into ciphertext for the response to the network. Additionally, or alternatively, the WTRU may determine to include a PQC-based signature, for example along with the ciphertext.

The WTRU may decapsulate the ciphertext to obtain the MSSK. For example when receiving a message from the network (e.g., SMF or PCF or UPF) via AMF/gNB, for setup of a secure end-to-end user plane connection and/or update of an existing secure end-to-end user plane connection and/or if a ciphertext IE is presented and/or a flag indicating the presence of ciphertext is included, the WTRU may decapsulate the ciphertext to obtain the MSSK. Additionally, or alternatively, for example if a PQC-based signature is along with the ciphertext, the WTRU may verify the signature before decapsulation.

The WTRU may perform a key derivation to obtain the session encryption and/or decryption key (e.g., Ken) and/or the integrity key (e.g., Kin), for example upon successful MSSK delivery. The WTRU may disable the confidentiality and/or integrity protection for (e.g., all) DRBs in the PDU session, for example upon receiving the indication (e.g., from RAN and/or SMF or based on a provisioned mobile network operator (MNO) security policy.

The RAN may disable the confidentiality and/or integrity protection for (e.g., all) DRBs in the PDU session, for example upon receiving the indication from SMF or based on a provisioned mobile network operator (MNO) security policy. The UPF, SMF, and/or PCF behavior may trigger the secure end-to-end user plane connection establishment and/or modification. A security keys update may be triggered by a timer expiration, data volume passing a limit, and/or security policy changing, for example for secure end-to-end user plane connection modification. A security policy update may include protecting the key distribution by the PQC algorithms (e.g., instead of conventional key exchange) and/or protecting the key distribution by the PQC algorithms with the higher security level. The PCF, SMF, and/or UPF may (e.g., already) store the WTRU PQC information, for example supported PQC algorithms and/or corresponding keys (e.g., encapsulation key and/or signing public key) for different security levels (e.g., before initiating the PQC-based E2E user plane security). The PCF, SMF, and/or UPF may provide the available information for the security setup/modification, for example when initiating the procedure.

The SMF and/or PCF may provide WTRU PQC parameter(s) (e.g., PQC KEM encapsulation key) to UPF, for example if the SMF and/or PCF trigger the procedure. The UPF may request that the WTRU generate the MSSK or may generate the MSSK (e.g., by the UPF). If UPF requests the WTRU to generate the MSSK for example, the UPF may send PQC keys (e.g., PQC.KEM.ek_UPF) to the WTRU. After receiving the ciphertext from WTRU for example, the UPF may decapsulate the ciphertext to obtain the MSSK. The UPF may encapsulate the MSSK with the stored WTRU encapsulation key (e.g., PQC.KEM.ek_UE), for example if the UPF generates the MSSK. The UPF and WTRU may perform a key derivation to obtain the session encryption and/or decryption key (e.g., Ken) and/or the integrity key (e.g., Kin), for example from the MSSK.

Systems and methods may provide PKI-based key distribution for E2E UP security, for example during PDU session establishment. A WTRU may send a PQC-based certificate, for example to a UPF. The PQC-based certificate may include a PQC KEM encapsulation key, a PQC DSA public key, and/or other parameters (e.g., E2E user plane security information). The WTRU may (e.g., first) verify a signature and/or (e.g., then) decapsulate the ciphertext to obtain the MSSK, for example after receiving the ciphertext. The WTRU may perform a key derivation to obtain the session encryption and/or decryption key (e.g., Ken) and/or the integrity key (e.g., Kin), for example from the MSSK. The WTRU may disable the confidentiality and/or integrity protection for (e.g., all) DRBs in the PDU session, for example upon receiving the indication (e.g., from RAN and/or SMF) or based on a provisioned mobile network operator (MNO) security policy.

The RAN may disable the confidentiality and/or integrity protection for (e.g., all) DRBs in the PDU session, for example upon receiving the indication from SMF or based on a provisioned mobile network operator (MNO) security policy. The SMF may verify the received WTRU PQC certificate and/or UPF PQC certificate with certificate authority (CA). The UPF may receive a request, for example from the SMF. The request may be for an N4 session setup, for example including an indication for PQC-based end-to-end user plane connection setup or modification, a WTRU PQC certificate, and/or a PDU Session ID. The UPF may sends information, for example to the SMF. The information may be used for the end-to-end user plane connection termination at the UPF (e.g., ciphertext, signature, and/or UPF PQC certificate). The UPF may perform a key derivation to obtain the session encryption and/or decryption key (e.g., Ken) and/or the integrity key (e.g., Kin), for example from the MSSK.

Systems and methods may provide PQC capability information exchange. Network capability on PQC may be broadcast, for example via SIB. The network capability may be broadcast on PQC-based subscription permanent identifier (SUPI) protection, for example for non-roaming cases. The network capability on PQC may be configured via a WTRU configuration update procedure. There may be exchange of capability on PQC via a registration procedure. A WTRU may provide a WTRU capability, for example via a registration request message. The WTRU may receive the network capability, for example via a registration response message. From a network perspective for example, the PQC capability may refer to the default PQC algorithms supported by network for (e.g., both) key encapsulation and/or digital signatures, and/or the corresponding security levels and/or PQC keys (e.g., for use cases). Use cases may include PQC-based secure E2E user plane connection between the WTRU and UPF, PQC-based SBI, PQC-based OAuth, PQC-based SUPI protection (e.g., non-roaming case), and/or PQC-based N2/N3/N4 interfaces. From the WTRU perspective, the PQC capability may refer to (e.g., all) PQC algorithms supported by the WTRU 902 for (e.g., both) key encapsulation and/or digital signatures, and/or the corresponding security levels and/or PQC keys (e.g., for use cases). Use cases may include PQC-based secure E2E user plane connection between the WTRU 902 and UPF, and/or PQC-based SUPI protection. Systems and methods herein may provide for PQC capability exchange via SIB, via registration, and/or via a WTRU configure update.

Systems and methods may provide post quantum attack and/PQC algorithms. Quantum-safe cryptography (QSC) may protect information exchange between individual users and/or data sources, for example using algorithms that are resistant to attacks by classical and/or quantum computers. QSC may keep this information secure even with the development of a mature quantum computing capability. Systems and methods may utilize post-quantum cryptographic algorithms, for example for key encapsulation (e.g., CRYSTALS-Kyber and/or HQC) and/or digital signature (e.g., CRYSTALS-Dilithium, SPHINCS+, and/or FALCON). Algorithms may be developed to resist against attacks, for example leveraging quantum computing.

ML-KEM may be referred to as CRYSTALS-Kyber. The ML-KEM (e.g., CRYSTALS-Kyber) algorithm may be a lattice-based key encapsulation mechanism (KEM), for example for secure key exchange. HQC may include a code-based key encapsulation mechanism, for example that may offer a stronger robustness than ML-KEM and/or a longer ciphertext. ML-DSA may be referred to as CRYSTALS-Dilithium. The ML-DSA (e.g., CRYSTALS-Dilithium) algorithm may include a lattice-based digital signature algorithm, for example providing strong security and/or efficiency. SLH-DSA may be referred to as SPHINCS+ and may include a stateless hash-based digital signature scheme, for example which may avoid dependence (e.g., only) on the security of lattices for signatures. FN-DSA may be referred to as FALCON and may include a lattice-based digital signature algorithm, for example which may utilize shorter public key size and/or signatures compared with other digital signature algorithms.

Table 1 shows examples of security levels and/or categories of cryptographic algorithms and PQC algorithms. Higher security levels and/or categories may include a longer key size and/or ciphertext/signature for example.

TABLE 1
Example comparison of security levels and/or categories.

| Security | AES/SHA (2/3) | |
|---|---|---|
| Level | Hardness | PQC Algorithms |
| 1 | AES-128 | ML-KEM-512, FN-DSA-512, |
| | | SLH-DSA-SHA2/SHAKE-128f/s |
| 2 | SHA-256/SHA3-256 | ML-DSA-44 |
| 3 | AES-192 | ML-KEM-768, ML-DSA-65, SLH- |
| | | DSA-SHA2/SHAKE-192f/s |
| 4 | SHA-384/SHA3-384 | No algorithm tested at this level |
| 5 | AES-256 | ML-KEM-1024, ML-DSA-87, FN- |
| | | DSA-1024, SLH-DSA- |
| | | SHA2/SHAKE-256f/s |

Systems and methods may implement 5G security, for example 5G security functions. 5G security functions may cover security domains within 5G systems. A security domain may include security for the network, access between a WTRU and a RAN/5GC, network domain security between a RAN and 5GC, and/or user domain security between mobile equipment (ME) (e.g., a WTRU) and universal subscriber identity module (USIM), and/or a SBA

domain security in 5GC. 5G network access security may be realized through network access authentication, message encryption, and/or message integrity protection. Network access authentication may include primary authentication and key agreement, and/or secondary authentication.

Primary authentication and key agreement may be configured to enable mutual authentication between WTRU and network, and/or agreed keying material (e.g., an anchor key KSEAF) at the network side and/or the WTRU side, for example, using authentication and key agreement (AKA) protocol. 5GC may leverage the authentication server function (AUSF), the UDM, and/or authentication credential repository and processing function (ARPF), for example to manage authentication methods, compute (e.g., necessary) data, and/or generate keying material. A subscription identifier de-concealing function (SIDF) may be utilized to derive the SUPI from the subscriber concealed identifier (SUCI), which for example may highlight the intricate authentication process within the home network core.

For 5G primary authentication and key agreement for example, the same long-term key K may be unique to a WTRU and/or may be (e.g., securely) maintained at the user service identity module (USIM) and/or the network. Based on the long-term key K for example, the anchor key KSEAF and/or other key materials (e.g., keys for encryption and integrity protection for NAS and AS signaling and user plane data) may independently and/or identically be derived at the WTRU and/or at network (e.g., without exchanging them over the air). Mutual authentication may be established, for example when the WTRU and network approve (e.g., to each other) the same long-term key K.

Secondary authentication may provide security between a WTRU and an external data network (DN), for example as a part of session management. Secondary authentication may utilize the SMF, for example to initiate and/or coordinate an authentication procedure between the WTRU and the DN (e.g., a DN-AAA Server). Additionally, or alternatively, authentication and key management for applications (AKMA) framework may introduce subscriber credentials and/or primary authentication results for authentication and key management at the application layer, for catering to internet of things (IoT) applications.

There may be an impact of quantum attacks to 3GPP systems and methods. Security threats posed by quantum technology to next generation networks, for example 6GS, are a concern. Currently symmetric and asymmetric cryptography are widely used in the 5G system. Symmetric cryptography may be used for the AKA protocol and/or the protection of the non-access stratum (NAS), access stratum (AS), and/or user plane on the air interface, for example using 128-bit symmetric key algorithms. Cryptographic strength may be enhanced, for example with symmetric 256-bit algorithms to bolster security (e.g., to NIST security level 5).

Public key cryptography may be utilized in (e.g., various) security domains, including network access security, network domain security, and/or service-based architecture (SBA) domain security, for example including SUPI protection, transport layer security (TLS)-based SBI, OAuth, TLS-based N2 and N4 interfaces, and/or IPSec-based N3 interface, etc. PQC algorithms may be utilized in 3GPP protocol specifications, for example in 6G. Systems and methods may be more secure for quantum computing by utilizing PQC protection across devices (e.g., WTRU, RAN, core network, and/or interconnect network), for example by expanding QSC to critical communication paths focusing on protecting the signature and/or authentication mechanisms across 3GPP (e.g., 5G) domains.

Use cases (e.g., in 5G) around user plane security enforcement may be oriented and/or limited to security policies towards the NG-RAN, for example based on the integrity and/or confidentiality protection activation on the air interface. Systems and methods may extend user plane security to end-to-end protection between a WTRU and the UPF, for example as a base station may be more vulnerable than other network entities (e.g., due to a larger number of deployments within a wireless system and/or diversity of deployment locations). Security key exchange between a WTRU and the UPF may be implemented. An authentication and key agreement (AKA) architecture (e.g., 5G) may be utilized to derive a shared key, for example from KAMF, KSEAF, and/or KAUSF, and/or forwarded to UPF for the end-to-end user plane security. Interfaces such as N4 and SBI, over which the derived shared key may be transmitted, may not sufficiently secure against quantum attacks, for example unless they are protected by PQC-based protocols like TLS or IPSec. Deriving keys may involve cryptographic hashes and/or HMAC, however the keys may be hacked during key derivation. Key derivation at other network entities may increase the risks. In a zero-trust network environment where no entity/interface is inherently trusted for example, the vulnerability may be greater.

Systems and methods (e.g., 6GS) may support enhanced secure end-to-end communication between the WTRU and the UPF, for example to guard against quantum attacks. PQC-based secure E2E WTRU-UPF interaction may also be referred to as PQC-based secure E2E user plane connection, and may be used to guard against quantum attacks. PQC-based secure E2E WTRU-UPF interaction may be utilized to provide robust defense mechanisms against potential quantum attacks, which may for example ensure the integrity and/or confidentiality of data transmitted across the network.

Systems and methods may provide an enhanced PQC-based E2E UP connection between a WTRU and the UPF. An enhanced PQC-based E2E UP connection may be utilized to secure security key distribution between the WTRU and the UPF to against the quantum attacks, allow the WTRU and/or the network (e.g., 6GS) to initiate the PQC-based secure end-to-end user plane connection, and/or allow the WTRU and/or the 6GS to (e.g., periodically) refresh the PQC-based connection by updating the security keys. Refreshing the PQC-based connection by updating security keys may ensure that the connection remains secure and/or resilient against potential threats by regularly incorporating new cryptographic keys. Additionally, or alternatively, an enhanced PQC-based E2E UP connection may be utilized to allow the WTRU and/or the network (e.g., 6GS) to refresh the PQC-based connection by updating the security keys on an event-driven basis (e.g., a security policy update), allow WTRU and network (e.g., 6GS) to exchange one or more of the PQC capability, (e.g., select) the PQC algorithms, and/or (e.g., corresponding) security level and keys, and/or support (e.g., both) non-roaming and/or roaming scenarios.

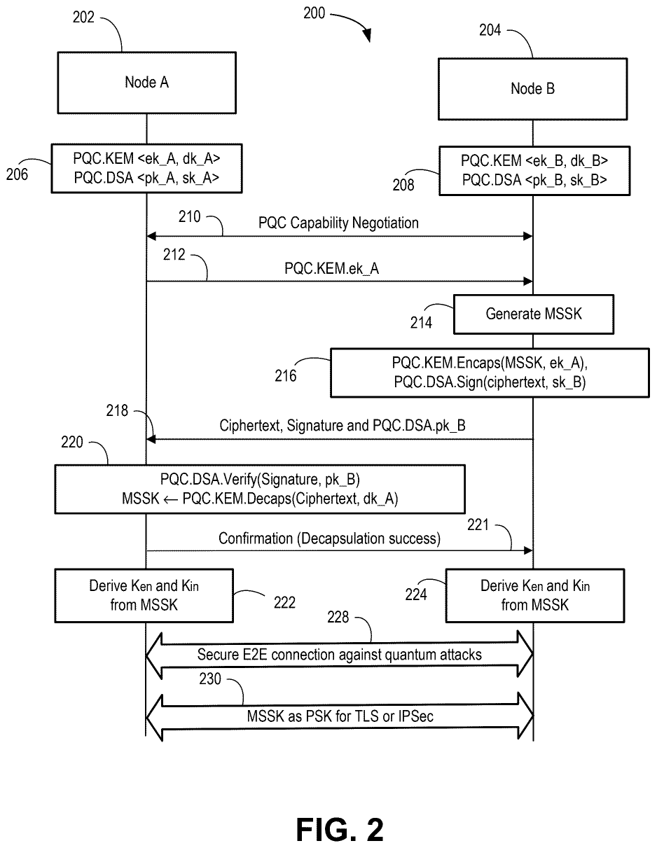

FIG. 2 is an example of post-quantum cryptography (PQC)-based key distribution 200. A high level key distribution procedure may include node A 202 and node B 204, which for example may perform the PQC-based key distribution 200. The PQC-based key distribution 200 may be utilized for end-to-end secure user plane protection and/or other use cases for example. Node A 202 and node B 204 may store a list of supported PQC KEM algorithms and PQC DSA algorithms at 206 and 208 respectively. For each PQC KEM algorithm for example, node A 202 and/or node B 204 may store the corresponding security level, encapsulation key, and/or decapsulation key pair (e.g., <ek, dk> pair). For each PQC DSA algorithm for node A 202 and/or node B 204 may store a (e.g., corresponding) security level, public key, and/or private key pair (e.g., <pk, sk> pair). Additionally, or alternatively, the PQC related information may be stored in a certificate, for example with the E2E user plane security information. E2E UP security information may include supported security algorithms for E2E security (e.g., confidentiality and/or integrity) and/or supported key derivation functions to derive the keys for confidentiality and/or integrity protection.

Node A 202 and/or node B 204 may be a WTRU, RAN node (e.g., gNB), and/or any 6G Network Function, for example eAMF, eSMF, eUPF, ePCF, and/or any new defined NFs in 6G. At 210 node A 202 and node B 204 may perform PQC capability negotiation, for example by PQC capability exchange. PQC capability exchange may include (e.g., default) PQC algorithms supported by network for (e.g., both) key encapsulation and/or digital signatures, and/or the corresponding security levels and/or PQC keys. Additionally, or alternatively, PQC capability exchange may include PQC keys in the capability information, for example because of the large size. PQC capability information may include E2E user plane security information, which for example may include the (e.g., default) security algorithms for E2E security (e.g., confidentiality and/or integrity), and/or default key derivation functions to derive the keys for confidentiality and/or integrity protection.

At 212 node A 202 may determine (e.g., select) a KEM algorithm and/or send a (e.g., corresponding) PQC KEM encapsulation key (e.g., PQC.KEM.ek_A) to node B 204. Node B 204 may verify the key, for example with a 6G security function. If node B 204 has received PQC.KEM.ek_A during capability exchange (e.g., at 210) for example, node A 202 may send, to node B 204, an indicator indicating which key is selected. At 214 node B 204 may generate a MSSK. At 216 node B 204 may encapsulate the MSSK with PQC.KEM.ek_A, into a ciphertext. The MSSK may be unique, for example for one connection, and/or one PDU session, etc. Node B 204 may include a signature along with the ciphertext for example.

At 218 node B 204 may send the ciphertext, signature, and/or PQC DSA public key (e.g., PQC.DSA.pk_B) to node A 202. Node A 202 may verify the key, for example with a 6G security function. If node A 202 has received the key during capability exchange (e.g., at 210) for example, node B 204 may send, to node A 202, an indicator indicating which key is selected. At 220 node A 202 may verify the signature, for example by using the node B 204 PQC DSA public key (e.g., if signature is received). Additionally, or alternatively, at 220 node A 202 may decapsulate the ciphertext with the PQC KEM decapsulation key (e.g., PQC.KEM.dk_A), for example to obtain MSSK.

At 221 node A 202 may send a confirmation of successful decapsulation to node B 204. Node A 202 and/or node B 204 may derive, at 222 and 224 respectively, Ken for session confidentiality protection, and/or derive Kin for session integrity protection, for example by using MSSK. At 228 node A 202 and node B 204 may establish a secure connection against quantum attacks. Confidentiality protection and/or integrity protection may be applied to TCP layer packets and/or IP layer packets between node A 202 and node B 204 for example. Additionally, or alternatively, at 230 the MSSK may be used in a secure transport protocol and/or IP protocol, for example TLS and/or IPSec, as a pre-shared key (PSK). The MSSK may (e.g., therefore) be utilized to establish a secure communication channel, for example ensuring data integrity and/or confidentiality during transmission. By employing the MSSK as a PSK for example, a system may enhance overall security posture and/or avoid use of a Diffie-Hellman algorithm for key generation (e.g., thereby providing a more robust defense against potential threats). The Diffie-Hellman algorithm may be susceptible to quantum attacks.

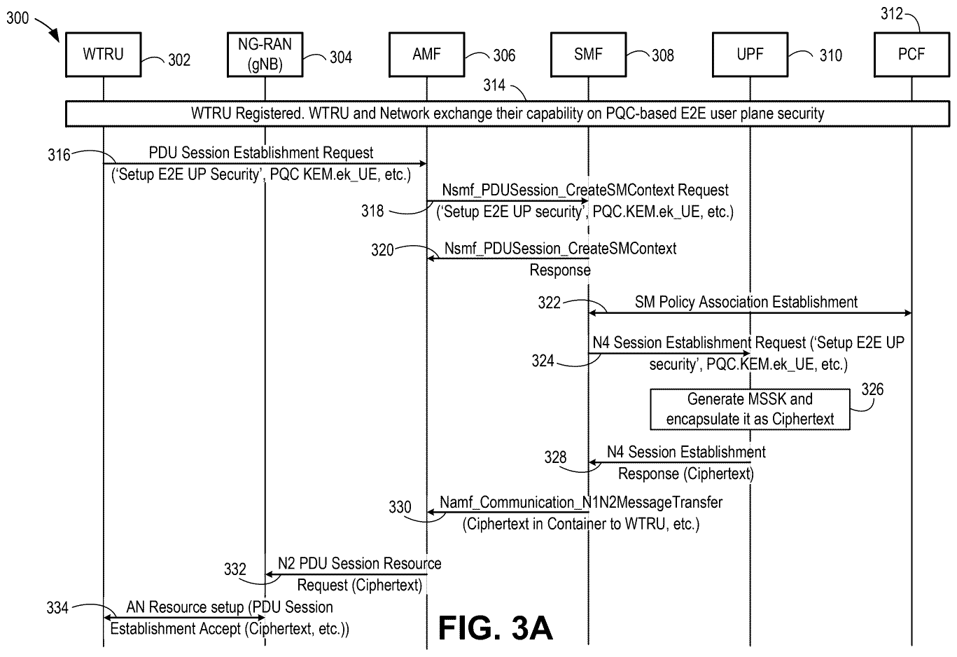

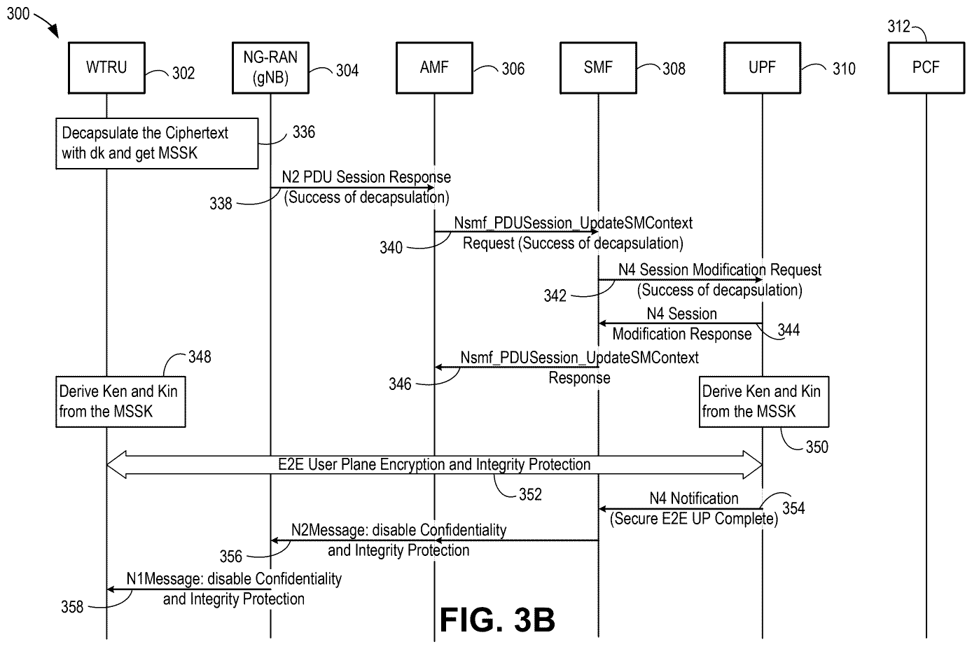

Systems and methods may provide WTRU initiated PQC-based key distribution for E2E UP security, for example during PDU session establishment. FIG. 3 is an example of WTRU initiated PQC-based key distribution for E2E UP security during PDU establishment 300. The PQC-based key distribution for E2E UP security 300 may be between a WTRU 302 and a UPF 310. At 314 the WTRU may register, for example the WTRU 302 and the network (e.g., NG-RAN 304, AMF 306, SMF 308, UPF 310, and/or PCF 312) may exchange capability, for example on PQC-based E2E UP security. The WTRU 302 may register to the network and/or setup secure AS and/or NAS connection. The 302 WTRU and the network may exchange their capability on PQC and/or E2E user plane security information, for example as discussed herein.

At 316 the WTRU 302 may initiate the key distribution procedure by sending an indication of setup a PQC-based E2E UP security, for example to UPF 310, for example via the NG-RAN 304, AMF 306, and/or SMF 308. Based on the information exchanged at 314 for example, the WTRU 302 may obtain an indication of the UPF 310 (e.g., default) capability on PQC, for example the default PQC algorithm/security level supported by the UPFs in the network. The WTRU 302 may select the PQC algorithm/security level based on the UPF (e.g., default) capability and the WTRU capability on PQC. The WTRU 302 may send a request message to the network to setup a PDU Session with PQC-based secure E2E user plane connection support.

The message may include an indicator to setup the E2E UP security, the selected PQC KEM algorithm, the corresponding security level and/or PQC KEM encapsulation key (e.g., PQC.KEM.ek_UE), an indicator of PQC-based signature set to Not needed, a PDU session ID for setting up the PQC-based secure E2E user plane connection, the E2E user plane security information (e.g., including the selected security algorithms for E2E security (e.g., confidentiality and/or integrity)), and/or selected key derivation functions to derive the keys for confidentiality and/or integrity protection.

If the WTRU 302 does not determine which security algorithms and/or which key derivation functions to use for example, the WTRU may include a list of supported security algorithms and/or key derivation functions (e.g., in the message at 316). The WTRU may include an indication for always-on PDU session. Information from 316 and/or 314 may be used by the UPF 310, for example to determine how to exchange the MSSK with the WTRU 302 with PQC protection, how to derive the encryption/decryption key and/or integrity key for the PDU session, and/or how to protect the session data. The information may be included in a UL NAS transport part of the message.

At 318 the AMF 306 may send the indication of setup a PQC-based E2E UP security to the SMF 308. The AMF 306 may select the SMF 308 and forward parameters to the SMF 308. At 320 the SMF 308 may respond to the AMF 306 with a Nsmf_PDUSession_CreateSMContext Response. The SMF may check whether the PDU session with PQC-based E2E user plane security is allowed, for example based on session management subscription data and/or may send a response to the AMF 306 (e.g., accordingly).

At 322 the SMF 308, UPF 310, and/or PCF 312 may perform SM policy association establishment. If dynamic policy control and charging (PCC) is used for example, the SMF 308 may request a policy association creation indicating a PQC-based E2E user plane connection and/or security capabilities for the connection. The SMF 308 may receive PCC rules from the PCF, for example including the PQC-based E2E user plane security control information, which may be used for the UPF 310 to initiate the PQC-based key distribution for E2E UP security (e.g., WTRU capability on PQC as herein). The PCC rules may alternatively, or additionally, include criteria for PQC-based E2E user plane security update, for example the frequency and/or triggers based on which the security keys may be updated and/or the WTRU 302 may be re-authenticated.

An example trigger may be based on a time duration, for example indicating the time period for which security keys may be used for a given session over the PQC-based E2E user plane connection between the WTRU 302 and the UPF 310. When the timer expires for example, the UPF 310 may determine to perform an update of the session keys with the WTRU 302. Another example trigger may be based on a data volume limit that may be exchanged between the WTRU 302 and the UPF 310, for example before changing the keys. The UPF may determine to perform an update of the session keys with the WTRU 302, for example when a data volume limit is exceeded. A 6GS initiated security key update procedure may be as described herein.

At 324 the SMF 308 may send the indication of setup a PQC-based E2E UP security to the UPF 310. The SMF 308 may select a UPF 310 that includes support for PQC-based secure E2E user plane connection, for example the PQC algorithm chosen by the WTRU 302 (e.g., at 316). The SMF 308 may use WTRU location information, for example to select the UPF 310 that is most suitable to serve the WTRU 302 (e.g., local UPF). The SMF 308 may send a request to the UPF 310 for N4 session setup, for example with an indication for PQC-based secure E2E user plane connection, selected PQC KEM algorithm, the corresponding security level, PQC KEM encapsulation key (e.g., PQC.KEM.ek_UE), PDU session ID, and/or E2E user plane security information. The SMF 308 may send an indication to the UPF 310 as to whether the secure PQC-based E2E user plane connection is for a new PDU session or an existing one.

At 326 the UPF 310 may generate a MSSK and/or encapsulates the MSSK into ciphertext. The UPF 310 may (e.g., after receiving the request from SMF 308) generate the MSSK, for example if the indication for PQC-based E2E secure user plane connection and/or other parameters are present. This MSSK may be unique for the PDU session. The UPF 310 may encapsulate the MSSK with the provided WTRU PQC.KEM.ek_UE, for example into a ciphertext. UPF 310 may select the security algorithm for E2E security (e.g., confidentiality and/or integrity), select the key derivation function(s) to derive the keys for confidentiality and/or integrity protection, for example if the WTRU does not select them.

At 328 the UPF 310 may send the ciphertext back to WTRU 302, for example via the SMF 308, the AMF 306, and/or the NG-RAN 304. The UPF 310 may send a feedback response message to the SMF 308, for example with the ciphertext.

Additionally, or alternatively, the UPF 308 may include a PQC-based signature, for example with the ciphertext to protect the integrity. At 330 the SMF 308 may send the ciphertext to the AMF 306. The SMF 308 may send the message to the AMF 306, for example including information (e.g., N1 SM info) for the WTRU 302 via the AMF 306 and/or the NG-RAN (e.g., gNB) 304. The information may include the PDU session ID, the ciphertext, selected security algorithms for E2E security and/or selected key derivation functions, and/or criteria for PQC-based E2E user plane security update. The NG-RAN (e.g., gNB) 304 receive a response (e.g., N2 SM info) via the AMF 306 from the SMF 308.

At 332 the AMF 306 may send the ciphertext to the NG-RAN 304. At 334 the NG-RAN 304 may send the ciphertext to the WTRU 302 and/or the WTRU 302 and the NR-RAN 304 may perform access network (AN) resource setup. The WTRU 302 may receive a response containing the ciphertext for PQC-based secure E2E user plane connection, a flag indicating the presence of ciphertext, a PDU session ID, the selected security algorithms for E2E security (e.g., confidentiality and/or integrity), and/or selected key derivation functions to derive the keys for confidentiality and integrity protection. At 336, the WTRU may (e.g., first) verify the signature and/or (e.g., then) decapsulate the ciphertext to obtain the MSSK. If the ciphertext IE is presented or a flag indicating the presence of ciphertext is included for example, the WTRU 302 may decapsulate the ciphertext with the PQC.KEM.dk_UE to obtain the MSSK. WTRU may send a response with an indicator of successful decapsulation of ciphertext, for example to the NG-RAN (e.g., gNB) 304.

At 338 the NG-RAN 304 may send an indication of decapsulation success to the AMF 306. At 340 the AMF 306 may send the indication of decapsulation success to the SMF 308. At 342 the SMF 308 may send indication of decapsulation success to the UPF 310. At 344 the UPF 310 may send a N4 session modification response to the SMF 308. At 346 the SMF 308 may send a Nsmf_PDUSession_UpdateSMContext Response to the AMF 306. After successful PDU session establishment, the WTRU 302 and/or the UPF 310 may perform a key derivation to obtain the session encryption/decryption key (e.g., Ken) and/or the integrity key (e.g., Kin) at 348 and 350 respectively, for example from the MSSK.

At 352 E2E UP encryption and/or integrity protection may be established, for example between the WTRU 302, the NG-RAN 304, and the UPF 310. For example the WTRU 302 may establish a PQC-based secure E2E user plane connection with the UPF 310. At 354 the UPF 310 may send a secure E2E UP complete message to the SMF 308, for example indicating successful WTRU-UPF secure connection establishment. Additionally, or alternatively, the MSSK may be used in a secure transport protocol/IP protocol (e.g., TLS, IPSec), for example as a pre-shared key (PSK).

At 356 the SMF 308 may send a disable confidentiality and/or integrity protection message to the AMF 306. The AMF 306 may send the message to the NR-RAN (e.g., gNB) 304 including a PDU session ID, a confidentiality protection indication set to Not needed, and/or an integrity protection indication set to Not needed. Based on the confidentiality protection indication and/or the confidentiality protection indication presence for example, the NR-RAN (e.g., gNB) 304 may disable the confidentiality protection and/or integrity protection of user plane data on air interface for (e.g., all) DRBs (e.g., within that PDU session).

Additionally, or alternatively, at 356 and at 358 the SMF 308 may send a message to the WTRU 302 (e.g., via the AMF 306) including the PDU session ID, the confidentiality protection indication set to Not needed, and/or the integrity protection indication set to Not needed. The WTRU 302 may disable the confidentiality protection and/or integrity protection of user plane data on air interface for (e.g., all) DRBs (e.g., within the PDU session). For example, at 358 the NR-RAN 304 may send the disable confidentiality and/or integrity protection message to the WTRU 302.

Systems and methods may include WTRU initiated PQC-based key distribution for E2E UP security, for example during PDU session modification. A WTRU may initiate PQC-based E2E UP security for an established PDU session, for example if not previously initiated. The WTRU may update security keys, for confidentiality and/or integrity protection, by generating a new MSSK for an established secure E2E user plane connection. A different PQC KEM/DSA algorithm with different security levels may be selected for the key distribution. Security key update trigger(s) may be based on a timer, for example in the WTRU. The timer may indicate the period during which security keys may be used for a given session over the PQC-based E2E user plane connection. Security key update trigger(s) may be based on a data volume limit. The data volume limit (e.g., information) may be exchanged between the WTRU and UPF, for example before changing the keys.

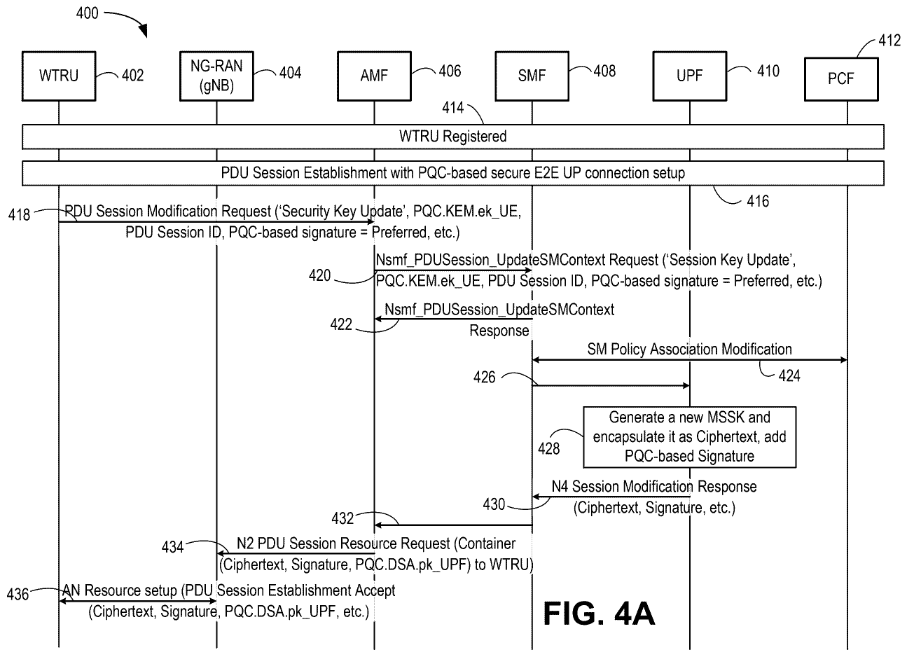

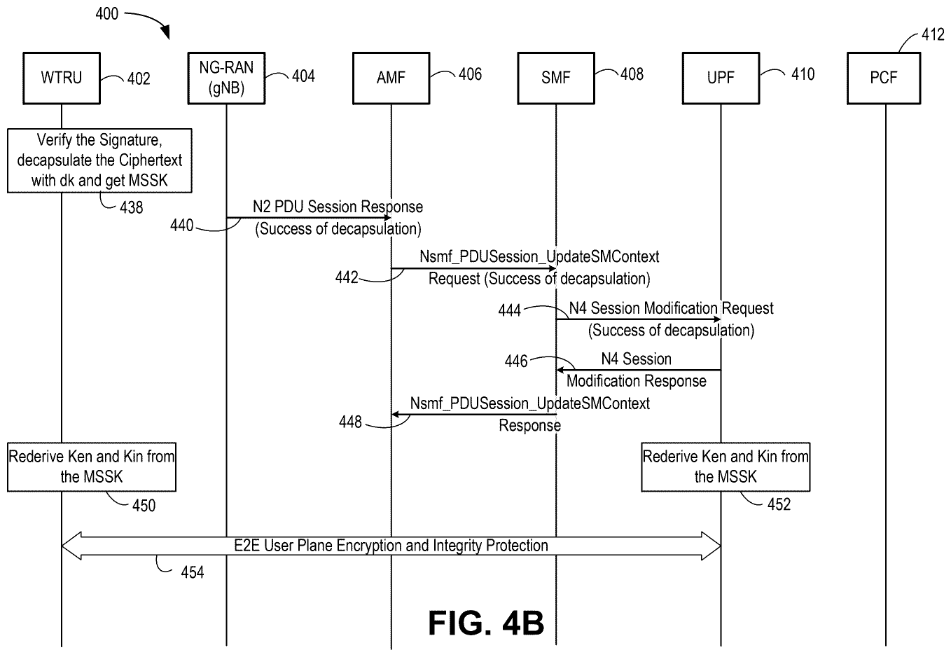

FIGS. 4A and 4B are an example of WTRU initiated PQC-based key distribution for E2E user plane security during PDU session modification 400. A MSSK with PQC for an established secure E2E user plane connection between a WTRU 402 and a UPF 410 may be refreshed, for example during a PDU Session Modification. The WTRU 402 may initiate the key distribution procedure 400, for example by sending an indicator of an E2E security update to the UPF 410. The (e.g., serving) UPF 410 may generate a MSSK and/or encapsulates the MSSK in ciphertext.

The UPF 410 may send the ciphertext back to WTRU 402. The UPF 410 may include a PQC-based signature, for example with the ciphertext. After receiving the ciphertext for example, the WTRU 402 may verify the signature and/or (e.g., then) decapsulate the ciphertext to obtain the MSSK. After successful MSSK delivery for example, the WTRU 402 and/or the UPF 410 may perform a key derivation to obtain the session encryption/decryption key (e.g., Ken) and/or the integrity key (e.g., Kin) from the MSSK. In FIGS. 4A and 4B, a PQC-bases signature is included.

At 414 the WTRU 402 may be registered to the network and/or may setup a secure AS and/or NAS connection. At 416 the WTRU 402 may setup a PDU session and/or setup the PQC-based secure E2E user plane connection for the established PDU session. At 418 the WTRU 402 may send a PDU session modification request message to the AMF 406, for example to initiate the PQC-based E2E user plane security and/or to request a PQC-based security keys update. In FIGS. 4A and 4B, WTRU 402 initiates PQC-based security keys update.

The WTRU 402 may determine (e.g., select) to use the same PQC algorithm/security level as that used in the E2E UP connection setup. The WTRU 402 may determine (e.g., select) a different PQC KEM/DSA algorithm with different security levels, for example based on the UPF 410 capability and/or the WTRU 402 capability on PQC. If the WTRU 402 decides to use a different PQC algorithm and/or different security level for example, the WTRU 402 may include the new PQC KEM algorithm, the corresponding security level, and/or PQC KEM encapsulation key (e.g., PQC.KEM.ek_UE) in the message 418. The UPF 410 may (e.g., otherwise) use the same algorithm as in the previous setup.

The WTRU 402 may include an indicator of a PQC-based signature set to Preferred, a PDU Session ID for modifying the PQC-based secure E2E user plane connection, E2E user plane security information. E2E UP security information may include selected security algorithms for E2E security (e.g., confidentiality and/or integrity) and/or selected key derivation functions to derive the keys for confidentiality and/or integrity protection.

At 420 the AMF 406 may send (e.g., forward) the parameters (e.g., from 418) to the SMF 408, for example in a request message. At 422 the SMF 408 (e.g., upon receiving the message from AMF) may check whether the session key update for PQC-based E2E user plane security is allowed, for example based on session management subscription data. The SMF 408 may send a response to the AMF 406 (e.g., accordingly).

At 424 the SMF 408 may request a policy association modification, for example to update the security capabilities and/or other parameter for the PQC-based E2E user plane connection. At 426 the SMF 408 may send a request to the UPF 410 for N4 session modification, for example including an indication for security key update for the established PQC-based secure E2E user plane connection, a PQC KEM algorithm, a corresponding security level, a PQC KEM encapsulation key (e.g., PQC.KEM.ek_UE), an indicator of PQC-based signature set to Preferred, a PDU session ID, and/or E2E user plane security information.

At 428 (e.g., upon receiving the request from the SMF 408) the UPF 410 may generate a MSSK for security keys update. The UPF may encapsulate the MSSK with the provided WTRU PQC.KEM.ek_UE into a ciphertext and/or (e.g., then) add a PQC-based signature with a PQC DSA sign private key (e.g., PQC.DSA.sk_UPF). At 430 the UPF 410 may send a response message to the SMF 408, for example including the ciphertext, signature, and/or PQC DSA sign public key (e.g., PQC.DSA.pk_UPF).

At 432 the SMF 408 may send a message to the AMF 406, for example including information (e.g., N1 SM information) for the WTRU 402 (e.g., via the AMF 406 and/or the NR-RAN/gNB 404). The information may additionally, or alternatively, include the PDU session ID, the ciphertext, signature, PQC.DSA.pk_UPF, selected security algorithm(s) for E2E security (e.g., confidentiality and integrity) and/or the selected key derivation functions to derive the keys for confidentiality and/or integrity protection, for example if the WTRU 402 does not select the security algorithms.

At 434 the NG-RAN (e.g., gNB) 404 may receive a response (e.g., N2 SM info) from the SMF 408, for example via the AMF 406. At 436 the WTRU 402 may receive the response (e.g., N1 SM info) (e.g., from the SMF 408), for example including the ciphertext and/or signature for MSSK update, a PDU session ID, selected security algorithms for E2E security (e.g., confidentiality and integrity), and/or selected key derivation functions to derive the keys for confidentiality and/or integrity protection. At 438 the WTRU 402 may verify the signature and/or (e.g., then) obtain the MSSK from the decapsulation the ciphertext with PQC.KEM.dk_UE. The WTRU 402 may send a response including an indicator of successful decapsulation of ciphertext.

At 440 the NG-RAN 404 may send an indication of decapsulation success to the AMF 406. At 442 the AMF 406 may send the indication of decapsulation success to the SMF 408. At 444 the SMF 408 may send an indication of decapsulation success to the UPF 410. At 446 the UPF 410 may send a N4 session modification response to the SMF 408. At 448 the SMF 408 may send a Nsmf_PDUSession_UpdateSMContext Response to the AMF 406. After successful MSSK delivery, the WTRU 402 and/or the UPF 410 may perform a key derivation to obtain the session encryption/decryption key (e.g., Ken) and/or the integrity key (e.g., Kin) at 450 and 452 respectively, for example from the MSSK. At 454 E2E UP encryption and/or integrity protection may be established, for example between the WTRU 402, the NG-RAN 404, and/or the UPF 410.

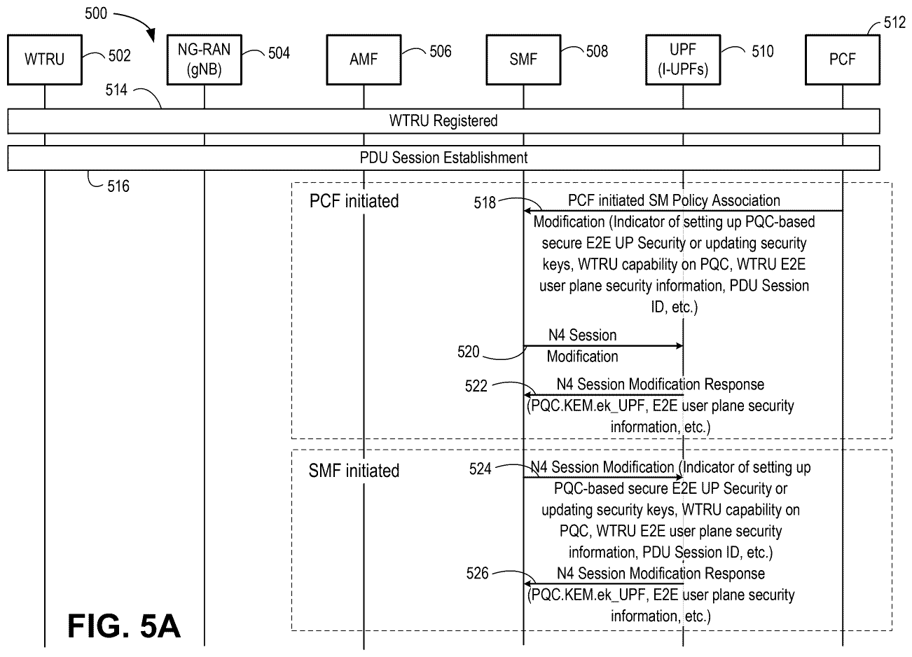

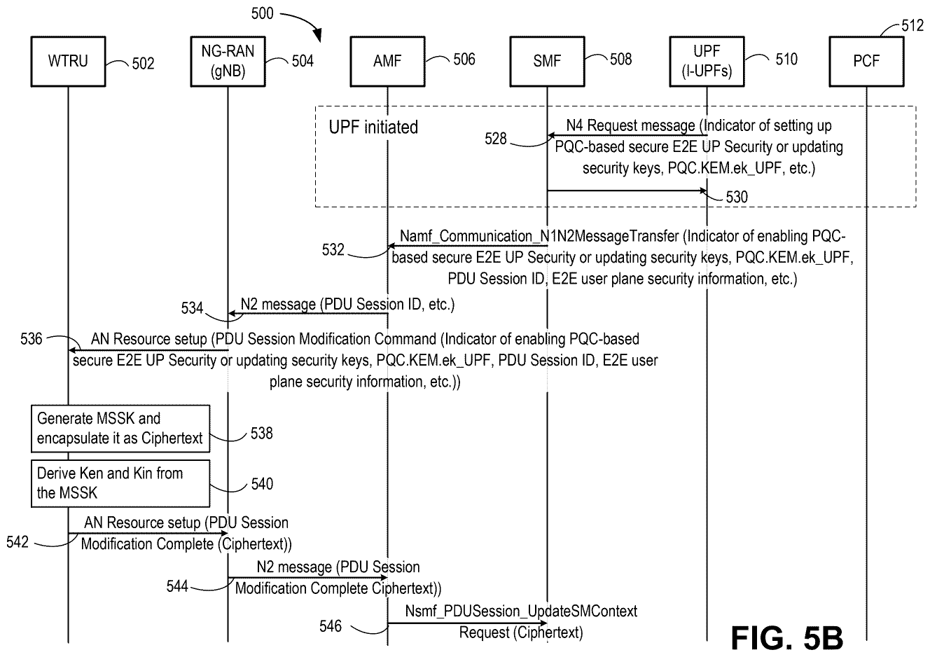

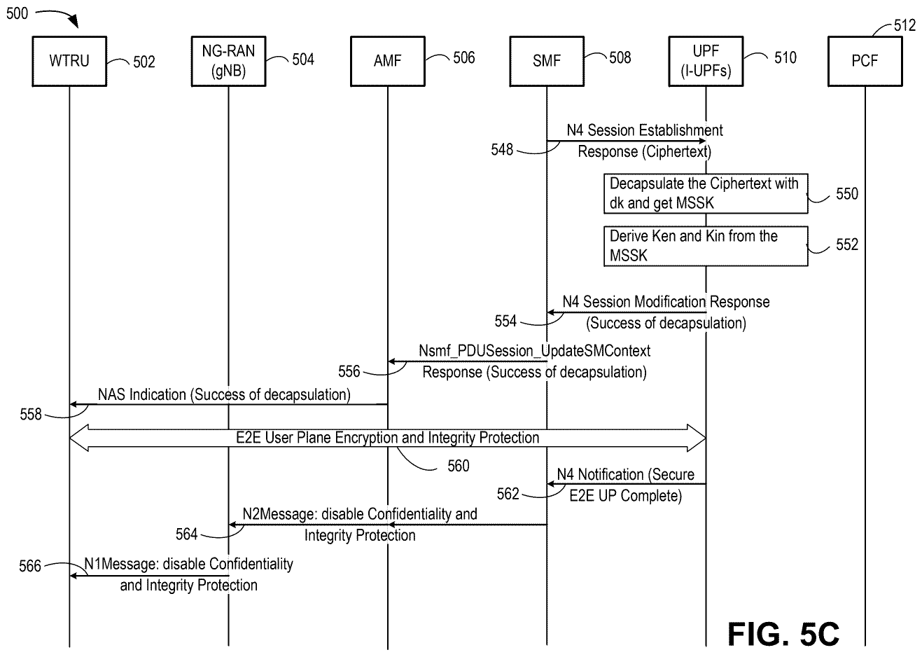

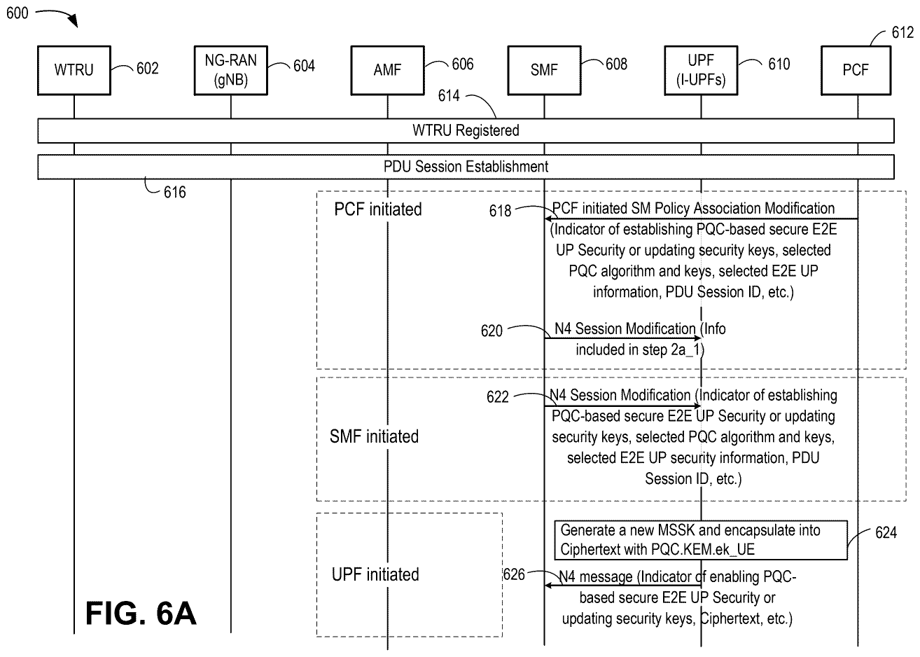

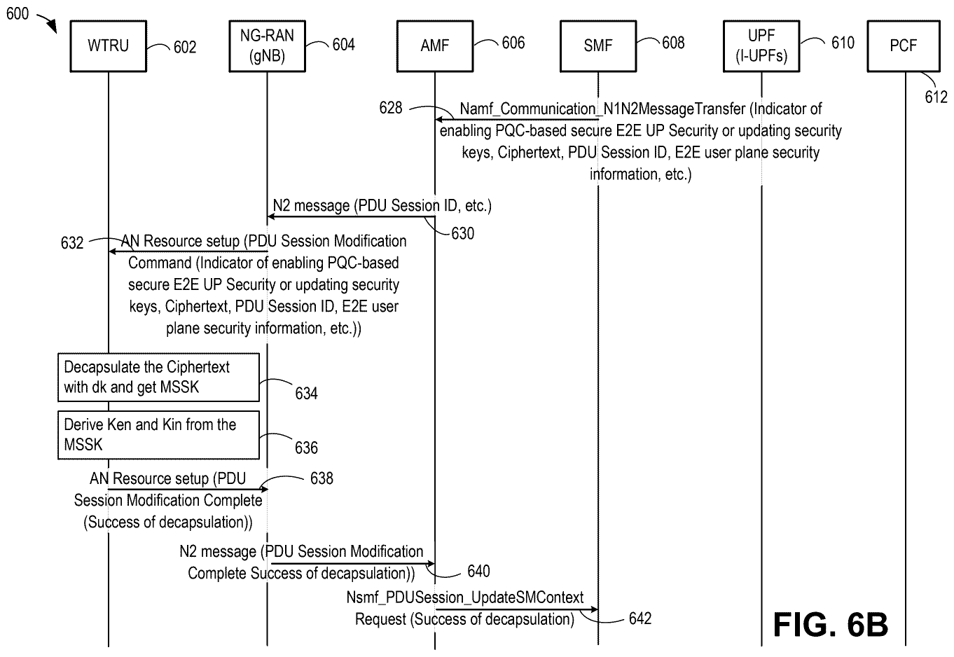

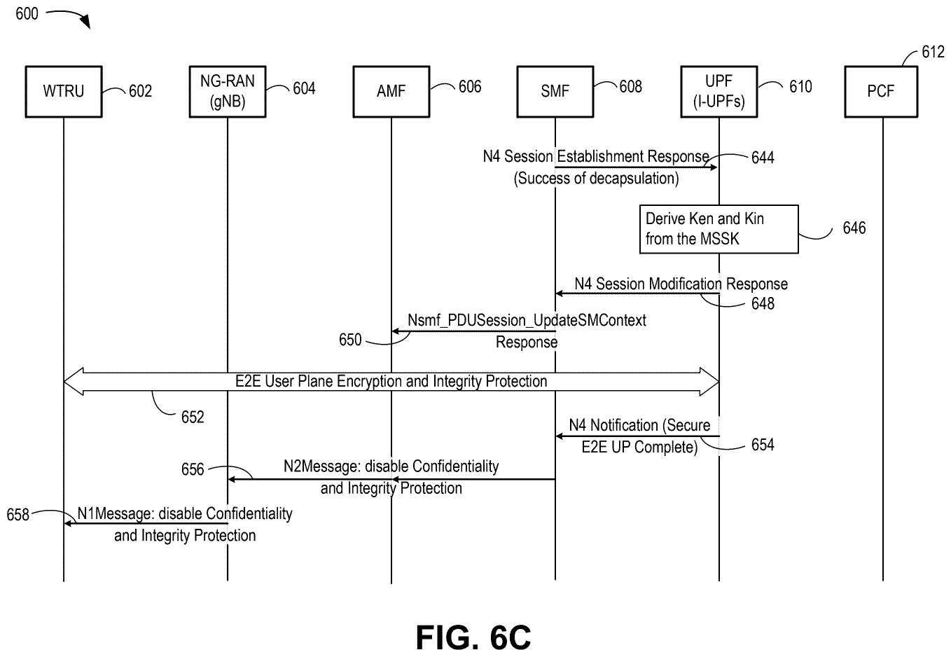

Systems and methods may include network initiated PQC-based key distribution for E2E UP security. FIGS. 5A-6C illustrate examples for establishing and/or modifying a PQC-based E2E UP connection between the WTRU and a UPF, which may be initiated by a PCF, SMF, and/or UPF, for example during a PDU session modification. Modifying a PQC-based secure E2E user plane connection may utilize a security keys update, a timer expiration trigger, a data volume limit, and/or a security policy update (e.g., protecting the key distribution by the PQC algorithms with the higher security level).

Different PQC algorithms with different security levels may be used, for example for a security keys update. A new MSSK may be generated and/or protected by the same PQC algorithms with the same security level used in the previous MSSK generation. A new MSSK may be generated and/or protected the same PQC algorithms with the different security level. A new MSSK may be generated and/or protected by a different PQC algorithms with the same security level. A new MSSK may be generated and/or protected by a different PQC algorithms with different security level.

Systems and methods may include network initiation of a key distribution procedure during PDU session modification, for example where a WTRU may generate the MSSK. FIGS. 5A, 5B, and 5C are an example of network initiated PQC-based key distribution for E2E user plane security during PDU session modification 500. The network may initiate the key distribution procedure, for example by sending an indicator to initiate the key distribution procedure for setting up E2E UP security and/or updating the security key. A WTRU 502 may generate a MSSK and/or encapsulate the MSSK into ciphertext. The WTRU 502 may send the ciphertext back to a UPF 510. The WTRU 502 may include a PQC-based signature, for example along with the ciphertext. The UPF 510 (e.g., after receiving the ciphertext) may verify the signature and/or (e.g., then) decapsulate the ciphertext, for example to obtain the MSSK. The WTRU 502 and/or the UPF 510 may perform a key derivation to obtain the session encryption/decryption key (e.g., Ken, and/or the integrity key (e.g., Kin) from the MSSK. A PQC-based signature may not be included in FIGS. 5A, 5B, and 5C.

At 514 the WTRU 502 may register to the network and/or setup a secure AS and/or NAS connection. At 516 the WTRU 502 and network may exchange capability on PQC and/or E2E user plane security information, for during the registration procedure and/or PDU session establishment procedure. A 6G network NF (e.g., SMF, PCF, UPF) for example may store the WTRU capability on PQC (e.g., the supported PQC algorithms and corresponding keys (e.g., encapsulation key and/or signing public key) for different security levels.

Establishing and/or modifying a PQC-based E2E UP connection between the WTRU and a UPF may be initiated by a PCF, SMF, and/or UPF. If the PCF 512 initiates the PQC-based secure E2E user plane connection establishment and/or modification for example, the PCF may send a SM policy association modification request to the SMF 508 at 518. The request may include an indicator to set up PQC-based E2E user plane security and/or updating security keys, a PDU session ID, a WTRU capability on PQC, and/or a WTRU E2E user plane security information (e.g., the supported/selected security algorithms for E2E security (confidentiality and integrity), and/or supported/selected key derivation functions to derive the keys for confidentiality and/or integrity protection).

At 520 the SMF 508 may forward the message to the UPF 510 (e.g., upon receiving the request message). If the PCF 512 has the WTRU and UPF capability on PQC for example, the PCF 512 may determine the PQC algorithms selection. The PCF 512 may (e.g., otherwise) provide the UPF 510 with the WTRU capability, for example to assist with algorithm selection at the UPF 510. At 522 the UPF 510 may send a N4 response message to the SMF 508, for example including the selected PQC KEM algorithm, the corresponding security level and/or PQC KEM encapsulation key (e.g., PQC.KEM.ek_UPF), and/or selected E2E user plane security information, etc.

If the SMF 508 initiates the PQC-based secure E2E user plane connection establishment and/or modification for example, the SMF 508 may send a N4 session modification request to the UPF 510 at 524. The request may include an indicator to set up PQC-based E2E user plane security and/or update security keys, a PDU session ID for setup/modification of the PQC-based secure E2E user plane connection, a WTRU capability on PQC, and/or WTRU E2E user plane security information. If the SMF 508 knows the WTRU and UPF capability on PQC for example, the SMF 508 may make the selection of the PQC algorithms. The SMF 508 may (e.g., otherwise) provide the WTRU capability to the UPF 510 to assist with algorithm selection at the UPF 510.

Upon receiving the request message for example, the UPF 510 may select the PQC algorithm and/or corresponding security level based on the UPF capability on PQC and/or the received WTRU capability on PQC (e.g., if the SMF 508 does not select the PQC algorithm). At 526 the UPF 510 may send a response message, for example including the selected PQC KEM algorithm, and/or the corresponding security level and PQC KEM encapsulation key (e.g., PQC.KEM.ek_UPF). If the UPF 510 does not receive the WTRU E2E user plane security information (e.g., at 526) for example, the UPF 510 may include a list of supported security algorithms for E2E security (e.g., confidentiality and/or integrity) and/or supported key derivation functions to derive the keys for confidentiality and/or integrity protection (e.g., for the WTRU 502 to decide).

If the UPF 510 initiates the PQC-based secure E2E user plane connection establishment and/or modification for example, the UPF 510 may send a N4 request message to the SMF 508 at 528. The message may include an indicator to setup PQC-based E2E user plane security and/or update security keys, a PDU session ID, the selected PQC KEM algorithm, the corresponding security level and/or PQC KEM encapsulation key (e.g., PQC.KEM.ek_UPF), and/or E2E user plane security information, etc. If the UPF 510 does not know the WTRU E2E user plane security information for example, the UPF 510 may include a list of supported security algorithms for E2E security (e.g., confidentiality and/or integrity) and/or supported key derivation functions to derive the keys for confidentiality and integrity protection (e.g., for the WTRU to decide).

At 532 the SMF 508 may forward the parameters (e.g., from the message) to the AMF 506, for example in a N1N2MessageTransfer message. At 532 the SMF 508 may send a message (e.g., N1 SM info) to the WTRU 502 (e.g., via the AMF 506 and/or NR-RAN/gNB 504), for example for one PDU session. The message may include the PDU session ID, the PQC.KEM.ek_UPF, the selected/supported security algorithms for E2E security (e.g., confidentiality and/or integrity), and/or selected/supported key derivation functions to derive the keys for confidentiality and integrity protection. The message may include a message (e.g., N2 SM info) to the NG-RAN/gNB 504 via the AMF 506 at 534, for example for one PDU session. The message may include the PDU session ID. At 534 the NG-RAN/gNB may receive the message (e.g., N2 SM info) from the SMF 508.

At 536 the WTRU 502 may receive a message (e.g., N1 SM info) from the SMF 508 (e.g., via the AMF 508 and/or NG-RAN/gNB 504), for example including the PQC.KEM.ek_UPF for PQC-based E2E user plane security, a PDU session ID and/or the selected/supported security algorithms for E2E security (e.g., confidentiality and/or integrity), and/or selected/supported key derivation functions to derive the keys for confidentiality and integrity protection.

At 538 the WTRU 502 may generate a MSSK and/or encapsulate the MSSK into ciphertext, for example with the received PQC.KEM.ek_UPF. At 540 the WTRU 502 may derive the Ken for session data encryption and/or decryption, and/or the Kin for session data integrity protection. At 542 and 544 the WTRU 502 may send a response message to the AMF 506 (e.g., via the NG-RAN/gNB 504), for example including the ciphertext, the selected security algorithms for E2E security (e.g., confidentiality and/or integrity), and/or selected key derivation functions to derive the keys for confidentiality and/or integrity protection (e.g., if the UPF 510 only provides a list of supported algorithms).

At 544 the NG-RAN/gNB 504 may send the ciphertext and/or other parameters (e.g., of the message) to the AMF 506. At 546 and 548 the AMF 506 may send the ciphertext and/or other parameters (e.g., of the message) to the UPF 510 (e.g., via the SMF 508). At 548 the UPF 510 may obtain the MSSK from the decapsulation the ciphertext, for example with PQC.KEM.dk_UPF. At 552 the UPF 510 may derive the Ken for session data encryption and/or decryption, and/or the Kin for session data integrity protection. At 554 the UPF 510 may respond to the SMF 508, for example with an indicator of successful decapsulation of ciphertext.

The WTRU may receive the indicator of successful decapsulation of ciphertext at 558. After receiving the successful decapsulation of ciphertext indication for example, the WTRU 502 may know that the key delivery is successful. A PQC-based secure E2E user plane connection may be established between WTRU and UPF at 560. Additionally, or alternatively, the MSSK may be used in a secure transport protocol/IP protocol (e.g., TLS, IPSec) as a pre-shared key (PSK).

At 562 the UPF 510 may send a notification to the SMF 508, for example indicating successful WTRU-UPF secure connection establishment. At 564 the SMF 508 may send a message to the NG-RAN/gNB 504, for example including a PDU session ID, a confidentiality protection indication set to Not needed, and/or an integrity protection indication set to Not needed. Based on the presence of the confidentiality protection indication and/or confidentiality protection indication for example, the NG-RAN/gNB 504 may disable the confidentiality protection and/or integrity protection of user plane data on air interface for (e.g., all) DRBs (e.g., within the PDU session). At 564 and 566 the SMF 508 may send a message to the WTRU 502, for example including a PDU session ID, a confidentiality protection indication set to Not needed, and/or an integrity protection indication set to Not needed. The WTRU 502 may disable the confidentiality protection and/or integrity protection of user plane data on air interface for (e.g., all) DRBs (e.g., within the PDU session).

Systems and methods may include network initiation of a key distribution procedure during PDU session modification, where for example the UPF may generate the MSSK. FIGS. 6A, 6B, and 6C are another example of network initiated PQC-based key distribution for E2E user plane security during PDU session modification 600.

At 614 the WTRU 602 may register to the network and/or setup a secure AS and/or NAS connection. At 616 the WTRU 602 and network may exchange capability on PQC and/or E2E user plane security information, for during the registration procedure and/or PDU session establishment procedure. Establishing and/or modifying a PQC-based E2E UP connection between the WTRU and a UPF may be initiated by a PCF, SMF, and/or UPF.

If the PCF 612 initiates the PQC-based secure E2E user plane connection establishment and/or modification for example, the PCF 612 may send a SM policy association modification request to the SMF 608 at 618. The request may include an indicator for setting up PQC-based E2E user plane security and/or updating security keys, a PDU session ID, WTRU PQC keys (e.g., PQC.KEM.ek_UE), security algorithms for E2E security (e.g., confidentiality and/or integrity), and/or the key derivation functions to derive the keys for confidentiality and/or integrity protection. If PCF does make the decision on algorithm selection for example, the PCF 612 may forward the WTRU capability to the UPF 610 to assist the algorithm selection at the UPF 610. At 620 the SMF 608 may send a N4 session modification, for example including information as in the request (e.g., at 618).

If the SMF 608 initiates the PQC-based secure E2E user plane connection establishment and/or modification for example, the SMF 608 may send a N4 session modification request to the UPF 610 at 622. The request may include an indicator for setting up PQC-based E2E user plane security and/or updating security keys, a PDU session ID for setup/modification of the PQC-based secure E2E user plane connection, WTRU PQC keys (e.g., PQC.KEM.ek_UE), security algorithms for E2E security (e.g., confidentiality and/or integrity), and/or key derivation functions to derive the keys for confidentiality and/or integrity protection. If the SMF 608 knows the WTRU and/or UPF capability on PQC for example, the SMF 608 may select the PQC algorithms. The SMF 608 may (e.g., otherwise) provide the WTRU capability to the UPF 610 to assist the algorithm selection at the UPF 610.

At 624 the UPF 610 may generate a new MSSK and/or encapsulate the MSSK into ciphertext, for example with WTRU PQC keys (e.g., PQC.KEM.ek_UE). At 626 the UPF 610 may forward the ciphertext to the SMF 608. With UPF initiation of the PQC-based secure E2E UP connection establishment and/or modification for example, the UPF 610 may generate a new MSSK and/or encapsulate the MSSK into ciphertext and/or forward the ciphertext to the SMF 608.

At 628 the SMF 608 may forward the parameters to the AMF 628, for example in a N1N2MessageTransfer message. At 630 and 632, the SMF 608 may send a message (e.g., N1 SM info) to the WTRU 602 (e.g., via the AMF 606 and/or NG-RAN/gNB 604), for example including the PDU session ID, ciphertext, the PQC algorithm to generate the ciphertext, the security algorithms for E2E security (e.g., confidentiality and/or integrity), and/or key derivation functions to derive the keys for confidentiality and/or integrity protection. The message may include a message (e.g., N2 SM info) to the NG-RAN/gNB 604 via the AMF 606 at 630. The message may include a message (e.g., N2 SM info) to the NG-RAN/gNB 604 via the AMF 606, for example for one PDU session. The message may include the PDU session ID. At 630 the NG-RAN/gNB 604 may receive the message (e.g., N2 SM info).

At 632 the WTRU 602 may receive a message (e.g., N1 SM info) from the SMF 608 (e.g., via the AMF 606 and/or NG-RAN/gNB 604), for example including the ciphertext and/or other information. At 634 the WTRU 602 may decapsulate the ciphertext to obtain the MSSK. At 636 the WTRU 602 may derive the Ken for session data encryption and/or decryption, and/or the Kin for session data integrity protection. The WTRU may respond with a success of decapsulation message at 638, for example to the AMF 608. The AMF 606 may send the success of decapsulation message to the SMF 608 at 642. The SMF 608 may send the success of decapsulation message to the UPF 610 at 644. After receiving the decapsulation of ciphertext indication for example, the UPF 610 may know that the key exchange is successful. At 646 the UPF 610 may derive the Ken and/or the Kin. A PQC-based secure E2E user plane connection is established between WTRU and with the UPF.

At 648 the UPF 610 may send a N4 session modification response to the SMF 608. At 650 the SMF 608 may send a Nsmf_PDUSession_UpdateSMContext Response to the AMF 606. At 652 E2E UP encryption and/or integrity protection may be established, for example between the WTRU 602, the NG-RAN 604, and/or the UPF 610. For example the WTRU 602 may establish a PQC-based secure E2E user plane connection with the UPF 610. At 654 the UPF 610 may send a secure E2E UP complete message to the SMF 608, for example indicating successful WTRU-UPF secure connection establishment. Additionally, or alternatively, the MSSK may be used in a secure transport protocol/IP protocol (e.g., TLS, IPSec), for example as a pre-shared key (PSK).

At 656 the SMF 608 may send a disable confidentiality and/or integrity protection message to the NR-RAN (e.g., gNB) 604 via AMF 606. The SMF 608 may send the message to the NR-RAN (e.g., gNB) 604 including a PDU session ID, a confidentiality protection indication set to Not needed, and/or an integrity protection indication set to Not needed. Based on the confidentiality protection indication and/or the confidentiality protection indication presence for example, the NR-RAN (e.g., gNB) 604 may disable the confidentiality protection and/or integrity protection of user plane data on air interface for (e.g., all) DRBs (e.g., within that PDU session).

Additionally, or alternatively, at 656 and 658, the SMF 608 may send a message to the WTRU 602 (e.g., via the AMF 606) including the PDU session ID, the confidentiality protection indication set to Not needed, and/or the integrity protection indication set to Not needed. The WTRU 602 may disable the confidentiality protection and/or integrity protection of user plane data on air interface for (e.g., all) DRBs (e.g., within the PDU session). For example, at 658 the NR-RAN 604 may send the disable confidentiality and/or integrity protection message to the WTRU 602.

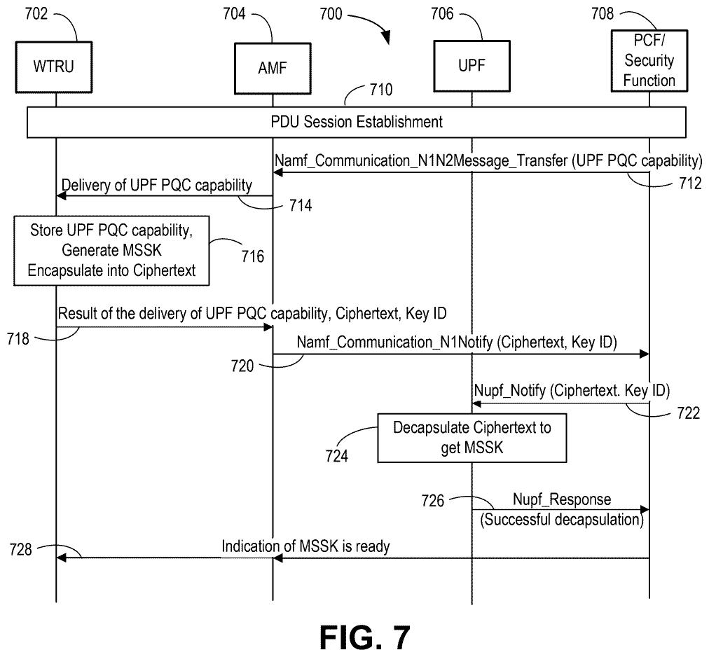

Systems and methods may include network initiation of the key distribution procedure during WTRU configuration update, where for example the WTRU may generate the MSSK. FIG. 7 is an example of a network initiated key distribution procedure during a user configuration update 700. The WTRU 702 may generate the MSSK and/or encapsulate the MSSK, for example with the received UPF PQC KEM encapsulation key.

At 710 there may be PDU session establishment, for example between the WTRU 702 and the network (e.g., AMF 704, UPF 706, and/or PCF/Security Function 708). The PCF/Security Function 708 may send a message to the WTRU 702 at 712, for example via the AMF 704. For example, the PCF/Security Function 708 may send the message to the AMF 704 and/or the AMF 704 may send the message to the WTRU 702. The message may include UPF PQC capability, for example PQC algorithms, and/or corresponding security level and/or encapsulation keys which may be indicated by a Key ID (e.g., <Key ID, PQC.KEM.ek_UPF>). The AMF 704 may deliver the message to the WTRU 702 at 714.

At 716 the WTRU 702 may generate a MSSK and/or encapsulate the MSSK into a ciphertext, for example with the UPF's PQC encapsulation key. At 718 the WTRU 702 may send a message to the AMF 704, for example to send the results of delivery of UPF PQC capability, the ciphertext, and/or a Key ID. The Key ID may be used to indicate which PQC algorithm/key is used to encapsulate the MSSK.

At 720 the AMF 704 may send a message to the PCF/Security Function 708, for example to send the results of PQC capability delivery, the ciphertext, and/or the Key ID. At 722 the PCF/Security Function 708 may send the ciphertext and/or Key ID to the UPF 706. At 724 the UPF 706 may decapsulate the ciphertext, for example using the PQC KEM decapsulation key indicated by the Key ID, to obtain the MSSK. At 726 the UPF 706 may notify the PCF/Security Function 708 of the success of decapsulation. At 728 the PCF/Security Function 708 may send a notification to the WTRU 702 (e.g., via the AMF 704) that the MSSK is ready.

Systems and methods may include PKI-based key distribution for E2E UP security. PKI-based key distribution may be used for E2E UP security establishment and/or update. A WTRU and/or UPF may exchange their PQC-based certificate, which for example may contain the PQC KEM encapsulation key, PQC DSA public key, and/or other parameters. Parameters may include parameters and discussed herein and/or E2E user plane security information. E2E security information may include supported security algorithms for E2E security (e.g., confidentiality and/or integrity), and/or supported key derivation functions to derive the keys for confidentiality and/or integrity protection. A PKI-based secure E2E user plane connection between the WTRU and UPF may be established during PDU session establishment and/or PDU session modification.

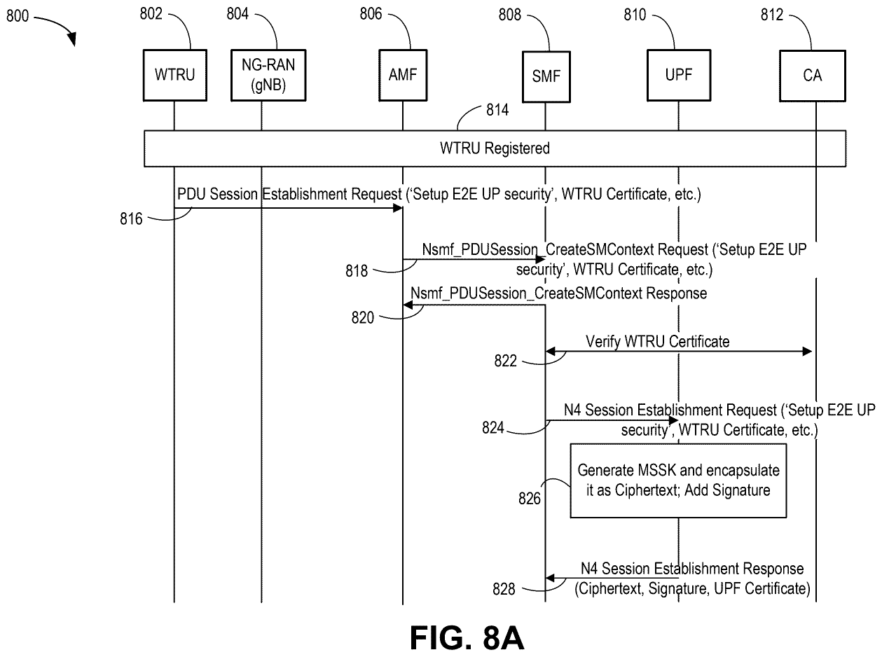

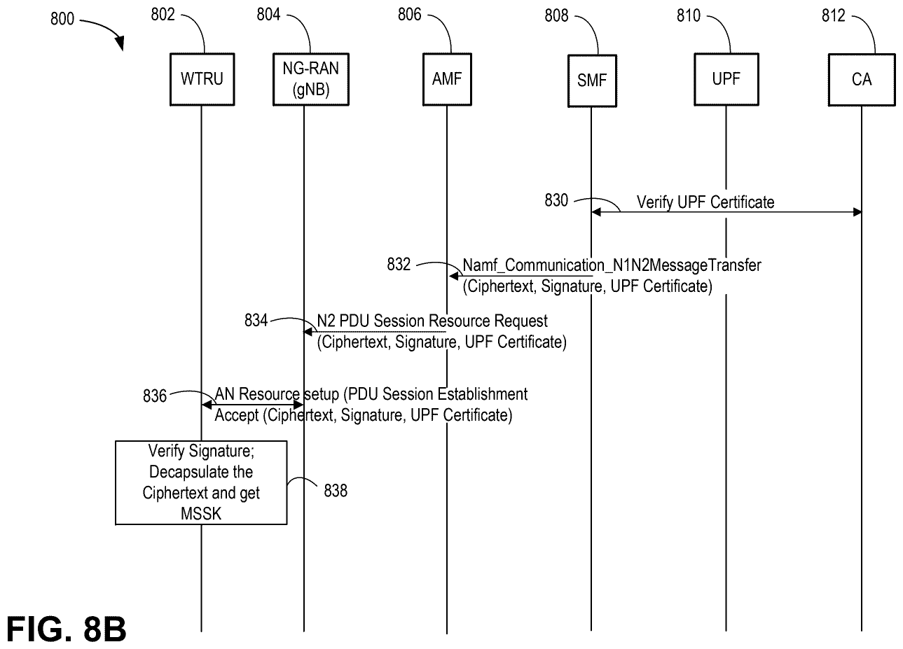

FIGS. 8A and 8B are an example of public key infrastructure (PKI)-based key distribution for E2E user plane security 800. An SMF 808 may verify the certificates on behalf of a WTRU 802 and/or UPF 810 for authentication. Alternatively, or additionally, other NFs (e.g., AMF 806 and/or new defined NF) may verify certificates. The SMF 808 may provide the UPF 810 with information that the WTRU 802 is authorized to connect with. The SMF 808 may provide the WTRU 802 with information that the UPF 810 is authorized to connect with.

At 814 the WTRU 802 is registered to the network. At 816 the WTRU may send a request message to the network, for example to setup a PDU session with PQC-based secure E2E user plane connection support. The message may include an indicator to set up the E2E UP security, a WTRU PQC Certificate, an indicator of PQC-based signature set to Preferred, and/or a PDU session ID for setting up the PQC-based secure E2E user plane connection.

At 818 the AMF 806 may select an SMF 808 and/or forward the parameters (e.g., request) to the SMF 808. At 820 the SMF may send a Nsmf_PDUSession_CreateSMContext response to the AMF 806. The SMF 808 may send a request to a certificate authority (CA) 812 to verify WTRU certificate at 822.

The SMF 808 may select a UPF 810 with support for a PQC-based secure E2E user plane connection. The SMF 808 may use WTRU 802 location information to select the UPF 810 that is most suitable to serve the WTRU 802 (e.g., local UPF 810). At 824 the SMF 808 may send a request to the UPF 810 for N4 session setup, for example including an indicator to setup the E2E UP security, a WTRU PQC certificate, an indicator of PQC-based signature, and/or a PDU Session ID. The UPF 810 may generate a MSSK at 826. The UPF 810 may encapsulate the MSSK into a ciphertext at 826, for example with the provided PQC.KEM.ek_UE in the certificate and/or sign with the PQC DSA public key (e.g., PQC.DSA.pk_UPF). At 828 the UPF 810 may feedback a response message to the SMF 808, for example with the ciphertext and the certificate.

The SMF 808 may send a request to the CA 812 to verify UPF certificate at 830. At 832 the SMF 808 may send a message to the AMF 806, for example including information (e.g., N1 SM info) for the WTRU 802 (e.g., via AMF 808 and/or and NG-RAN/gNB 804) including the PDU session ID, the ciphertext, and/or UPF Certificate. The message may be sent in a response (e.g., N2 SM info) to the NG-RAN/gNB 804 via the AMF 808 at 834.

At 836 the NG-RAN 804 may send the ciphertext to the WTRU 802 and/or the WTRU 802 and the NR-RAN 804 may perform access network (AN) resource setup. At 838, If the ciphertext IE is presented or a flag indicating the presence of ciphertext is included for example, the WTRU 802 may (e.g., first) verify the signature and/or (e.g., then) decapsulate the ciphertext to obtain the MSSK. WTRU 802 may send a response with an indicator of successful decapsulation of ciphertext, for example to the NG-RAN (e.g., gNB) 804.

The NG-RAN 804 may send an indication of decapsulation success to the AMF 806. The AMF 806 may send the indication of decapsulation success to the SMF 808. The SMF 808 may send indication of decapsulation success to the UPF 810. The UPF 810 may send a N4 session modification response to the SMF 808. The SMF 808 may send a Nsmf_PDUSession_UpdateSMContext Response to the AMF 806. After successful MSSK delivery, the WTRU 802 and/or the UPF 810 may perform a key derivation to obtain the session encryption/decryption key (e.g., Ken) and/or the integrity key (e.g., Kin), for example from the MSSK. E2E UP encryption and/or integrity protection may be established, for example between the WTRU 802, the NG-RAN 804, the UPF 810. For example the WTRU 802 may establish a PQC-based secure E2E user plane connection with the UPF 810. The UPF 810 may send a secure E2E UP complete message to the SMF 808, for example indicating successful WTRU-UPF secure connection establishment. Additionally, or alternatively, the MSSK may be used in a secure transport protocol/IP protocol (e.g., TLS, IPSec), for example as a pre-shared key (PSK).

The SMF 808 may send a disable confidentiality and/or integrity protection message to the NR-RAN (e.g., gNB) 804 via AMF 806, including a PDU session ID, a confidentiality protection indication set to Not needed, and/or an integrity protection indication set to Not needed. Based on the confidentiality protection indication and/or the confidentiality protection indication presence for example, the NR-RAN (e.g., gNB) 804 may disable the confidentiality protection and/or integrity protection of user plane data on air interface for (e.g., all) DRBs (e.g., within that PDU session).

Additionally, or alternatively, the AMF 806 may send the disable confidentiality and/or integrity protection message to the WTRU 802 (e.g., via the AMF 806 and NR-RAN (e.g., gNB) 804) including the PDU session ID, the confidentiality protection indication set to Not needed, and/or the integrity protection indication set to Not needed. The WTRU 802 may disable the confidentiality protection and/or integrity protection of user plane data on air interface for (e.g., all) DRBs (e.g., within the PDU session). For example, the NR-RAN 804 may send the disable confidentiality and/or integrity protection message to the WTRU 802.

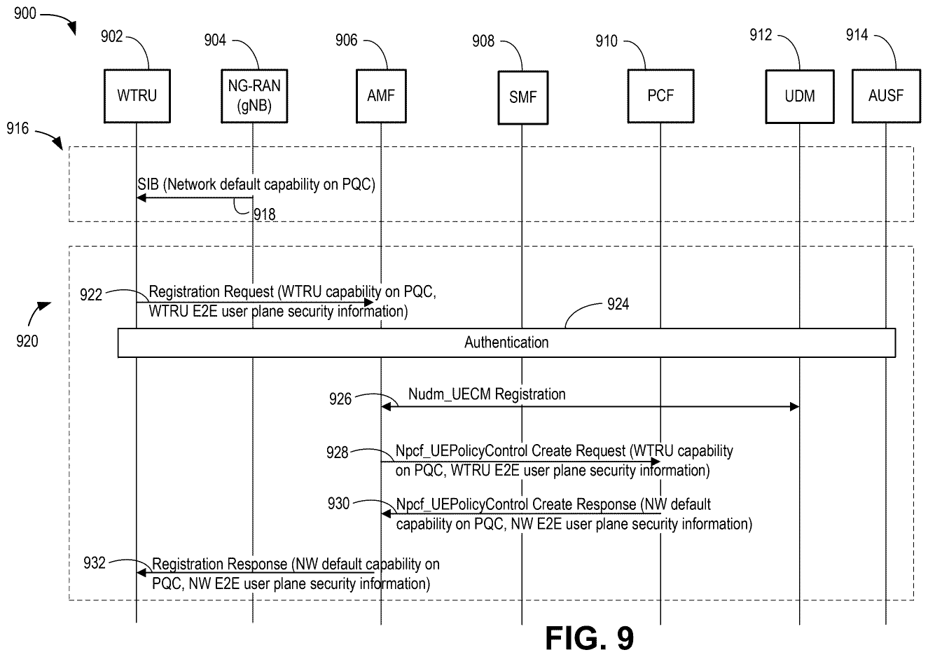

Systems and methods may include PQC capability information exchange. FIG. 9 is an example of capability information exchange 900, for example for a WTRU 902 and a network to share their capabilities on PQC. From a network perspective for example, the PQC capability may refer to the default PQC algorithms supported by network for (e.g., both) key encapsulation and/or digital signatures, and/or the corresponding security levels and/or PQC keys (e.g., for use cases). Use cases may include PQC-based secure E2E user plane connection between the WTRU and UPF, PQC-based SBI, PQC-based OAuth, PQC-based SUPI protection (e.g., non-roaming case), and/or PQC-based N2/N3/N4 interfaces.

From the WTRU 902 perspective, the PQC capability may refer to (e.g., all) PQC algorithms supported by the WTRU 902 for (e.g., both) key encapsulation and/or digital signatures, and/or the corresponding security levels and/or PQC keys (e.g., for use cases). Use cases may include PQC-based secure E2E user plane connection between the WTRU 902 and UPF, and/or PQC-based SUPI protection. E2E user plane security information may include (e.g., default) supported security algorithms for E2E security (e.g., confidentiality and/or integrity), and/or (e.g., default) supported key derivation functions to derive the keys for confidentiality and/or integrity protection. PQC keys may be included in the capability information, for example because of their large size.

At 916 the network may broadcast the network capability on PQC, for example via SIB. For example, capability broadcast on PQC-based SUPI protection may be used for non-roaming scenario. The NG-RAN 904 may send the broadcast network capability to the WTRU 902 at 918.

At 920 capability exchange on PQC may be via a registration procedure. The WTRU 902 may provide the WTRU capability in a registration request message at 922. The WTRU 902 may receive the network capability via a registration response message at 932.

The WTRU 902 may send a registration request message to the network to register to the network at 922. The WTRU 902 may include the WTRU capability on PQC as described herein. The WTRU 902 may additionally or alternatively include the E2E user plane security information, for example including the supported security algorithms for E2E security (e.g., confidentiality and/or integrity), and/or supported key derivation functions to derive the keys for confidentiality and/or integrity protection.

At 924 the WTRU 902 and the network may perform mutual authentication. At 926 the AMF 906 may register the WTRU 902 with the UDM 912. At 928 the AMF 906 may send a Npcf_UEPolicyControl Create Request to the PCF 910, for example to perform a WTRU policy association establishment. The AMF 906 may include a WTRU capability on PQC and/or E2E user plane security information in the message. At 930 the PCF 910 may provide a network default capability on PQC and/or default E2E user plane security information in a response message to the AMF 906.

At 932 the AMF 906 may send a registration response message to WTRU 902, for example with network default capability on PQC and/or default E2E user plane security information. The network PQC capability may refer to the default PQC algorithms supported by network for key encapsulation and/or digital signatures, and/or the corresponding security levels and PQC keys for different use cases. The message at 922 may not be protected by air interface security and/or the information in the message at 922 may be sent back in the response at 932. The WTRU 902 may verify the information in the response (e.g., at 932) is the same as the information in the message (e.g., at 922).

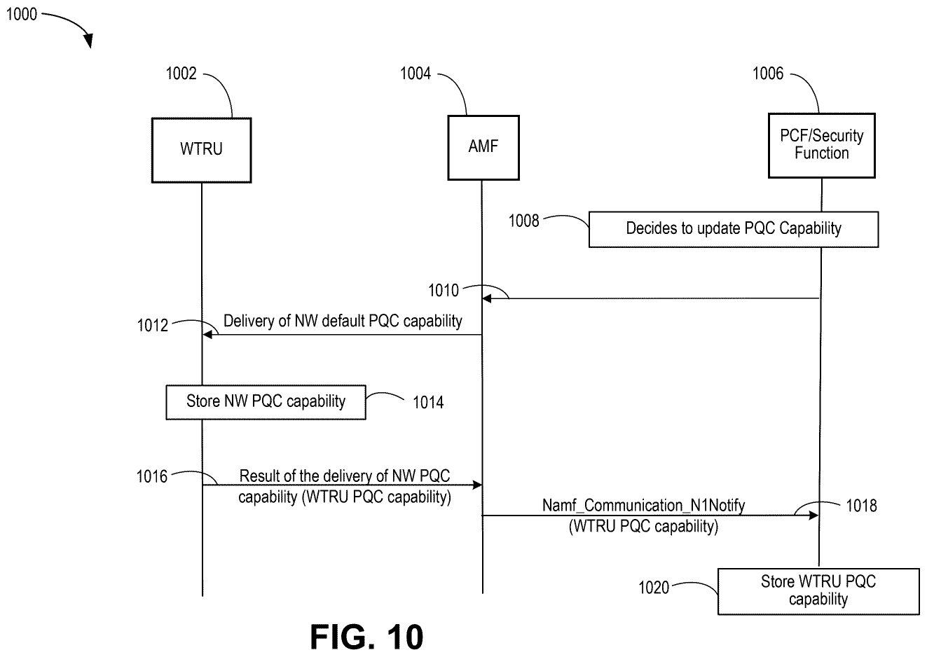

FIG. 10 is an example of capability exchange via a WTRU configuration update procedure 1000, for example where the PQC capability is exchanged via a WTRU configuration update procedure. A PCF or a 6G Security Function 1006 may determine to exchange or update the network PQC capability with a WTRU 1002. If the PCF/Security Function 1006 is located in the visiting network (VN) for example, the PCF/Security Function 1006 may share the VN's PQC capability. If PCF/Security Function locate in the home network (HN), it shares the HN's PQC capability. The PCF/Security Function 1006 may determine to update the PQC capability at 1008. At 1010 the PCF/Security Function may send a message to the AMF 1004. The message may include the network capability on PQC.

At 1012 the AMF 1004 may send the network capability on PQC to the WTRU 1002. The WTRU may store the network's capability on PQC at 1014. At 1016 the WTRU 1002 may send a message to the AMF 1004, for example to notify the results of delivery and share WTRU PQC capability with PCF/Security Function 1006. At 1018 the AMF 1004 may send a message to PCF/Security Function 1006, for example to notify the results of PQC capability delivery and share WTRU PQC capability with PCF/Security Function 1006. The PCF/Security Function 1006 may store the WTRU capability on PQC at 1020.

Systems and methods may include PQC-based key exchange for E2E UP security during home-routed roaming. For home-routed roaming for example, whether the WTRU or 6GS initiates the PQC-based key exchange for E2E User Plane security, the E2E User Plane connection may be between the WTRU and home UPF (H-UPF). The WTRU or H-UPF (e.g., either the WTRU or the H-UPF) may generate the MSSK, encapsulates the MSSK into a ciphertext, and/or decapsulate the ciphertext.

1. A wireless transmit/receive unit (WTRU) comprising:
a processor configured to:
send a message to a user plane function (UPF), the message comprising a post-quantum cryptography (PQC) key and an indication to establish or modify end to end (E2E) user plane (UP) security;
receive a master shared secret key (MSSK) from the UPF;
determine, based on the MSSK, a session key and an integrity key; and
establish or modify, based on the session key and the integrity key, a secure E2E UP connection with the UPF.

2. The WTRU of claim 1, wherein the MSSK is encapsulated in a ciphertext, and wherein the processor is configured to:
decapsulate the ciphertext to obtain the MSSK; and
send an indication of decapsulation success to the UPF.

3. The WTRU of claim 1, wherein the processor is configured to:
determine to use the MSSK as a pre-shared key (PSK) in a secure transport protocol or IP protocol; and
establish a communication protocol with the UPF using the PSK.

4. The WTRU of claim 1, wherein the message comprises a PQC certificate, a protocol data unit (PDU) session identifier (ID), and E2E user plane security information, and wherein the MSSK is based on the PQC key.

5. The WTRU of claim 1, wherein the processor is configured to receive a disable message, the disable message comprising an indication to disable confidentiality or integrity protection for a protocol data unit (PDU) session.

6. The WTRU of claim 1, wherein the processor is configured to:
receive a PQC capability associated with the UPF and a default capability; and
store the PQC capability associated with the UPF and the default capability in a memory.

7. A method performed by a wireless transmit/receive unit (WTRU), the method comprising:
sending a message to a user plane function (UPF), the message comprising a post-quantum cryptography (PQC) key and an indication to establish or modify end to end (E2E) user plane (UP) security;
receiving a master shared secret key (MSSK) from the UPF;
determining, based on the MSSK, a session key and an integrity key; and
establishing or modifying, based on the session key and the integrity key, a secure E2E UP connection with the UPF.

8. The method of claim 7, wherein the MSSK is encapsulated in a ciphertext, and wherein the method comprises:
decapsulating the ciphertext to obtain the MSSK; and
sending an indication of decapsulation success to the UPF.

9. The method of claim 7, comprising:
determining to use the MSSK as a pre-shared key (PSK) in a secure transport protocol or IP protocol; and
establishing a communication protocol with the UPF using the PSK.

10. The method of claim 7, wherein the message comprises a PQC certificate, a protocol data unit (PDU) session identifier (ID), and E2E user plane security information, and wherein the MSSK is based on the PQC key.

11. The method of claim 7, comprising receiving a disable message from the UPF, the disable message comprising an indication to disable confidentiality or integrity protection for a protocol data unit (PDU) session.

12. The method of claim 7, comprising:
receiving a PQC capability associated with the UPF and a default capability; and
storing the PQC capability associated with the UPF and the default capability in a memory.

13. A user plane function (UPF) comprising:
a processor configured to:
receive a first message from a wireless transmit/receive unit (WTRU), the first message comprising a post-quantum cryptography (PQC) key and an indication to establish or modify end to end (E2E) user plane (UP) security;
determine, based on the PQC key, a master shared secret key (MSSK) and include the MSSK in a second message;
send the second message comprising the MSSK to the WTRU;
determine, based on the MSSK, a session key and an integrity key; and
establish or modify, based on the session key and the integrity key, a secure E2E UP connection with the WTRU.

14. The UPF of claim 13, wherein the processor is configured to:
determine to use the MSSK as a pre-shared key (PSK) in a secure transport protocol or IP protocol; and
establish a communication protocol with the WTRU using the PSK.

15. The UPF of claim 13, wherein the processor is configured to exchange PQC capability information with the WTRU.

16. The UPF of claim 13, wherein the processor is configured to send a disable message to the WTRU, the disable message comprising an indication to disable confidentiality or integrity protection for a protocol data unit (PDU) session.

17. The UPF of claim 13, wherein the processor is configured to:
encapsulate the MSSK into a ciphertext; and
send the ciphertext comprising the MSSK in the second message to the WTRU.

18. The UPF of claim 13, wherein the first message comprises a PQC certificate, a protocol data unit (PDU) session identifier (ID), and E2E user plane security information, and wherein the MSSK is based on the PQC key.

19. The UPF of claim 13, wherein the processor is configured to establish a PDU session with the WTRU prior to receiving the first message comprising the PQC key.

20. The UPF of claim 13, wherein the processor is configured to:
receive, from the WTRU, an update to a PQC capability associated with the WTRU; and
store the PQC capability associated with the WTRU in a memory.
